(19) United States
(12) Patent Application Publication
(10) Pub. No.: US 2020/0234499 A1
(43) Pub. Date: Jul. 23, 2020

(54) METHOD FOR TRANSMITTING/RECEIVING MEDIA DATA AND DEVICE THEREFOR

(71) Applicant: LG ELECTRONICS INC., Seoul (KR)

(72) Inventors: Soojin HWANG, Seoul (KR); Hyunmook OH, Seoul (KR); Sejin OH, Seoul (KR)

(73) Assignee: LG ELECTRONICS INC., Seoul (KR)

(21) Appl. No.: 16/639,072

(22) PCT Filed: Nov. 6, 2018
(86) PCT No.: PCT/KR2018/013375

§ 371 Date: Feb. 13, 2020

Related U.S. Application Data
(60) Provisional application No. 62/583,486, filed on Nov. 8, 2017.
(60) Provisional application No. 62/590,349, filed on Nov. 23, 2017.

(51) Int. Cl. G06T 19/00; H04N 21/81; H04N 21/2343; H04N 21/233

(52) U.S. Cl. CPC G06T 19/006; H04N 21/816; G06F 3/013; H04N 21/2335; H04N 21/2343

(57) ABSTRACT

A media data processing method performed by a media processing apparatus, the media data processing method including: receiving information on reproduction environment of a media reproducing apparatus from the media reproducing apparatus, generating media signal by processing a media bitstream based on the information on reproduction environment, extracting characteristic information of the generated media signal and transmitting the generated media signal and the extracted characteristic information to the media reproducing apparatus, wherein the information on reproduction environment includes at least one of VR (Virtual Reality) reproduction environment information and AR (Augmented Reality) reproduction environment information.

### BACKGROUND OF THE DISCLOSURE

### Field of the Disclosure

The present disclosure relates to media data, and more particularly, to a method and apparatus for transmitting/receiving 3-dimensional (3D) media data.

### Related Art

A virtual reality (VR) system provides a user with sensory experiences through which the user may feel as if he/she were in an electronically projected environment. An Augmented Reality (AR) system overlay a three-dimensional (3D) virtual image on an actual image or background of a real word, thereby allowing a user to feel as if the user is placed in an environment where a virtual reality and the real word are mixed. A system for providing VR may be further improved in order to provide higher-quality images and spatial sound. The VR or AR system may enable the user to interactively enjoy VR or AR content.

With the increasing demand for the VR or AR content, there is a growing necessity for inventing a method capable of effectively transmitting/receiving media data between a device for generating media signal for reproducing the VR or AR content and a device for reproducing the VR or AR content.

### SUMMARY OF THE DISCLOSURE

The present disclosure provides a method and apparatus for transmitting/receiving media data.

The present disclosure also provides a media processing apparatus for generating a media signal while transmitting/receiving media data with respect to a media reproducing apparatus, and an operating method thereof.

The present disclosure also provides a media reproducing apparatus for reproducing a media signal while transmitting/receiving media data with respect to a media processing apparatus, and an operating method thereof.

The present disclosure also provides a method and apparatus for transmitting/receiving 3D media data.

The present disclosure also provides a media processing apparatus for generating a VR or AR media signal while transmitting/receiving VR or AR media data with respect to a media reproducing apparatus, and an operating method thereof.

The present disclosure also provide a media reproducing apparatus for reproducing a VR or AR media signal while transmitting/receiving VR or AR media data with respect to a media processing apparatus, and an operating method thereof.

According to an embodiment of the present disclosure, there is provided a media data processing method performed by a media processing apparatus. The method includes: receiving information on reproduction environment of a media reproducing apparatus from the media reproducing apparatus, generating media signal by processing a media bitstream based on the information on reproduction environment, extracting characteristic information of the generated media signal, and transmitting the generated media signal and the extracted characteristic information to the media reproducing apparatus. The information on reproduction environment includes at least one of VR (Virtual Reality) reproduction environment information and AR (Augmented Reality) reproduction environment information.

According to another embodiment of the present disclosure, there is provided a media data reproducing method performed by a media reproducing apparatus. The method includes collecting information on reproduction environment of the media reproducing apparatus, transmitting the collected information on reproduction environment to a media processing apparatus, receiving from the media processing apparatus a media signal generated by processing a media bitstream in the media processing apparatus on the basis of the information on reproduction environment and characteristic information extracted from the generated media signal, and generating the received media signal, based on the extracted characteristic information. The information on reproduction environment includes at least one of VR reproduction environment information and AR reproduction environment information.

According to another embodiment of the present disclosure, there is provided a media data processing apparatus for processing media data. The media data processing apparatus includes a receiver for receiving information on reproduction environment of a media reproducing apparatus from the media reproducing apparatus, a media signal processor for generating a media signal by processing a media bitstream based on the information on reproduction environment, a metadata processor for extracting characteristic information of the generated media signal, and a transmitter for transmitting the generated media signal and the extracted characteristic information to the media reproducing apparatus. The information on reproduction environment includes at least one of VR reproduction environment information and AR reproduction environment information.

According to another embodiment of the present disclosure, there is provided a media reproducing apparatus for reproducing media data. The media reproducing apparatus includes a metadata processor for collecting information on reproduction environment of the media reproducing apparatus, a transmitter for transmitting the collected information on reproduction environment to the media processing apparatus, a receiver for receiving from the media processing apparatus a media signal generated by the media processing apparatus by processing a media bitstream on the basis of the information on reproduction environment and characteristic information extracted from the generated media signal, and a reproducer for reproducing the received media signal, based on the extracted characteristic information. The information on reproduction environment includes at least one of VR reproduction environment information and AR reproduction environment information.

According to the present disclosure, there is provided a method in which a media processing device and a media reproducing device can effectively transmit/receive 3D media data.

According to the present disclosure, there is provided a method in which a media processing device and a media reproducing device can effectively transmit/receive VR or AR media data.

According to the present disclosure, there is provided a method in which a media processing device generates a VR or AR media signal for more effective reproduction in a media reproducing device on the basis of reproduction environment information of the media reproducing device, received from the media reproducing device.

According to the present disclosure, there is provided a method in which an audio reproducing device effectively reproduces a VR or AR media signal, based on characteristic information of the VR or AR media signal obtained in a process of generating the VR or AR media signal by processing VR or AR media bitstream, received from the media processing device.

### BRIEF DESCRIPTION OF THE DRAWINGS

FIG. 1 is a diagram showing an overall architecture for providing 360 content according to an embodiment of the present disclosure.

FIGS. 2 and 3 are diagrams illustrating the structure of a media file according to an embodiment of the present disclosure.

FIG. 4 is a diagram illustrating the overall operation of a DASH-based adaptive streaming model according to an embodiment of the present disclosure.

FIG. 5 is a diagram illustrating the concept of aircraft principal axes to explain a 3D space according to an embodiment.

FIG. 6 exemplarily illustrates a 2D image to which a 360 video processing process and a region-wise packing process based on a projection format are applied.

FIG. 7a and FIG. 7b exemplarily illustrate projection formats according to an embodiment.

FIG. 8a and FIG. 8b illustrate a tile according to an embodiment.

FIG. 9 is a block diagram illustrating a structure of a media processing device according to an embodiment.

FIG. 10 is a block diagram illustrating a structure of a media reproducing device according to an embodiment.

FIG. 11 is a block diagram illustrating a structure of a media processing device and media reproducing device according to an embodiment.

FIG. 12 is a flowchart illustrating a process in which a media reproducing device transmits EDID information to a media processing device according to an embodiment.

FIG. 13 is a flowchart illustrating a process in which a media processing device processes media data according to an embodiment.

FIG. 14 is a flowchart illustrating a process in which a media reproducing device reproduces media data according to an embodiment.

FIG. 15 is a flowchart illustrating a process in which a media processing device and a media reproducing device transmit/receive media data according to an embodiment.

### DESCRIPTION OF EXEMPLARY EMBODIMENTS

The present disclosure may be modified in various forms, and specific embodiments thereof will be described and illustrated in the drawings. However, the embodiments are not intended for limiting the disclosure. The terms used in the following description are used to merely describe specific embodiments, but are not intended to limit the disclosure. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the disclosure are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the disclosure without departing from the concept of the disclosure.

Hereinafter, preferred embodiments of the present disclosure will be described in more detail with reference to the attached drawings. Hereinafter, the same reference numbers will be used throughout this specification to refer to the same components and redundant description of the same component may be omitted.

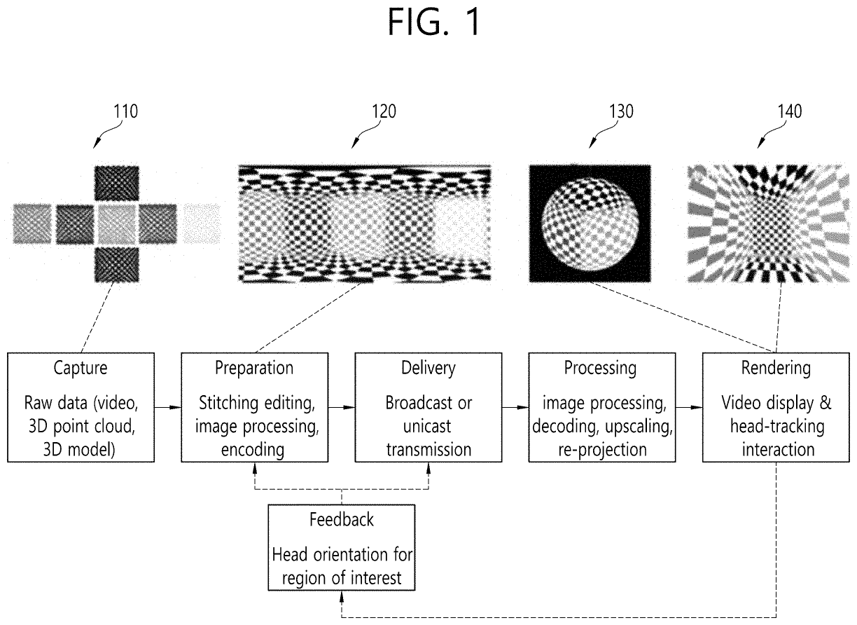

FIG. 1 is a diagram showing an overall architecture for providing 360 contents according to an embodiment of the present disclosure.

In order to provide a user with Virtual Reality (VR), a scheme for 360 content provision may be considered. Here, the 360-degree content may be called a three Degrees of Freedom (3DoF) contents, and VR may mean technology or an environment for replicating an actual or virtual environment or may mean the actual or virtual environment itself. VR artificially allow a user to experience with senses, and, through this experience, the user may feel as if he/she were in an electronically projected environment.

The term “360 content” means all content for realizing and providing VR, and may include 360-degree video and/or 360 audio. The term “360-degree video” and/or “360 audio” may be called a three-dimensional video and/or a three-dimensional audio. The term “360-degree video” may mean video or image content that is captured or reproduced in all directions (360 degrees) at the same time, which is necessary to provide VR. Hereinafter, the 360 video may refer to a 360 degree video. The 360-degree video may refer to a video or an image that appears in various kinds of 3D spaces depending on 3D models. For example, the 360-degree video may appear on a spherical surface. The term “360 audio”, which is audio content for providing VR, may refer to spatial audio content in which the origin of a sound is recognized as being located in a specific 3D space. The 360 audio may be called 3D audio. The 360 content may be generated, processed, and transmitted to users, who may enjoy a VR experience using the 360 content.

In order to provide a 360-degree video, the 360-degree video may be captured using at least one camera. The captured 360-degree video may be transmitted through a series of processes, and a reception side may process and render the received data into the original 360-degree video. As a result, the 360-degree video may be provided to a user.

Specifically, the overall processes of providing the 360-degree video may include a capturing process, a preparation process, a delivery process, a processing process, a rendering process, and/or a feedback process.

The capture process may refer to a process of capturing images or videos for a plurality of viewpoints through one or more cameras. Image/video data 110 shown in FIG. 1 may be generated through the capture process. Each plane of 110 in FIG. 1 may represent an image/video for each viewpoint. A plurality of captured images/videos may be referred to as raw data. Metadata related to capture can be generated during the capture process.

For capture, a special camera for VR may be used. When a 360 video with respect to a virtual space generated by a computer is provided according to an embodiment, capture through an actual camera may not be performed. In this case, a process of simply generating related data can substitute for the capture process.

The preparation process may be a process of processing captured images/videos and metadata generated in the capture process. Captured images/videos may be subjected to a stitching process, a projection process, a region-wise packing process and/or an encoding process during the preparation process.

First, each image/video may be subjected to the stitching process. The stitching process may be a process of connecting captured images/videos to generate one panorama image/video or spherical image/video.

Subsequently, stitched images/videos may be subjected to the projection process. In the projection process, the stitched images/videos may be projected on 2D image. The 2D image may be called a 2D image frame according to context. Projection on a 2D image may be referred to as mapping to a 2D image. Projected image/video data may have the form of a 2D image 120 in FIG. 1.

The video data projected on the 2D image may undergo the region-wise packing process in order to improve video coding efficiency. The region-wise packing process may be a process of individually processing the video data projected on the 2D image for each region. Here, the term “regions” may indicate divided parts of the 2D image on which the 360-degree video data are projected. In some embodiments, regions may be partitioned by uniformly or arbitrarily dividing the 2D image. Also, in some embodiments, regions may be partitioned depending on a projection scheme. The region-wise packing process is optional, and thus may be omitted from the preparation process.

In some embodiments, in order to improve video coding efficiency, this process may include a process of rotating each region or rearranging the regions on the 2D image. For example, the regions may be rotated such that specific sides of the regions are located so as to be adjacent to each other, whereby coding efficiency may be improved.

In some embodiments, this process may include a process of increasing or decreasing the resolution of a specific region in order to change the resolution for areas on the 360-degree video. For example, regions corresponding to relatively important areas in the 360-degree video may have higher resolution than other regions. The video data projected on the 2D image or the region-wise packed video data may undergo the encoding process via a video codec.

In some embodiments, the preparation process may further include an editing process. At the editing process, image/video data before and after projection may be edited. At the preparation process, metadata for stitching/projection/encoding/editing may be generated in the same manner. In addition, metadata for the initial viewport of the video data projected on the 2D image or a region of interest (ROI) may be generated.

The delivery process may be a process of processing and delivering the image/video data that have undergone the preparation process and the metadata. Processing may be performed based on an arbitrary transport protocol for delivery. The data that have been processed for delivery may be delivered through a broadcast network and/or a broadband connection. The data may be delivered to the reception side in an on-demand manner. The reception side may receive the data through various paths.

The processing process may be a process of decoding the received data and re-projecting the projected image/video data on a 3D model. In this process, the image/video data projected on the 2D image may be re-projected in a 3D space. Depending on the context, this process may be called mapping or projection. At this time, the mapped 3D space may have different forms depending on the 3D model. For example, the 3D model may be a sphere, a cube, a cylinder, or a pyramid.

In some embodiments, the processing process may further include an editing process and an up-scaling process. At the editing process, the image/video data before and after re-projection may be edited. In the case where the image/video data are down-scaled, the size of the image/video data may be increased through up-scaling at the up-scaling process. As needed, the size of the image/video data may be decreased through down-scaling.

The rendering process may be a process of rendering and displaying the image/video data re-projected in the 3D space. Depending on the context, a combination of re-projection and rendering may be expressed as rendering on the 3D model. The image/video re-projected on the 3D model (or rendered on the 3D model) may have the form as indicated by 130 in FIG. 1. The image/video indicated by 130 in FIG. 1 is re-projected on a spherical 3D model. The user may view a portion of the rendered image/video through aVR display. At this time, the portion of the image/video viewed by the user may have the form shown in (140) of FIG. 1.

The feedback process may be a process of transmitting various kinds of feedback information that may be acquired at a display process to a transmission side. Interactivity may be provided in enjoying the 360-degree video through the feedback process. In some embodiments, head orientation information, information about a viewport, which indicates the area that is being viewed by the user, etc. may be transmitted to the transmission side in the feedback process. In some embodiments, the user may interact with what is realized in the VR environment. In this case, information related to the interactivity may be provided to the transmission side or to a service provider side at the feedback process. In some embodiments, the feedback process may not be performed.

The head orientation information may be information about the position, angle, and movement of the head of the user. Information about the area that is being viewed by the user in the 360-degree video, i.e. the viewport information, may be calculated based on this information.

The viewport information may be information about the area that is being viewed by the user in the 360-degree video. Gaze analysis may be performed therethrough, and therefore it is possible to check the manner in which the user enjoys the 360-degree video, the area of the 360-degree video at which the user gazes, and the amount of time during which the user gazes at the 360-degree video. The gaze analysis may be performed on the reception side and may be delivered to the transmission side through a feedback channel. An apparatus, such as a VR display, may extract a viewport area based on the position/orientation of the head of the user, a vertical or horizontal FOV that is supported by the apparatus, etc.

In some embodiments, the feedback information may not only be delivered to the transmission side, but may also be used in the reception side. That is, the decoding, re-projection, and rendering processes may be performed in the reception side using the feedback information. For example, only the portion of the 360-degree video that is being viewed by the user may be decoded and rendered first using the head orientation information and/or the viewport information.

Here, the viewport or the viewport area may be the portion of the 360-degree video that is being viewed by the user. The viewport, which is the point in the 360-degree video that is being viewed by the user, may be the very center of the viewport area. That is, the viewport is an area based on the viewport. The size or shape of the area may be set by a field of view (FOV), a description of which will follow.

In the entire architecture for 360-degree video provision, the image/video data that undergo a series of capturing/projection/encoding/delivery/decoding/re-projection/rendering processes may be called 360-degree video data. The term “360-degree video data” may be used to conceptually include metadata or signaling information related to the image/video data.

In order to store and transmit media data such as the above-described audio or video, a formalized media file format may be defined. In some embodiments, the media file according to the present disclosure may have a file format based on ISO base media file format (ISO BMFF).

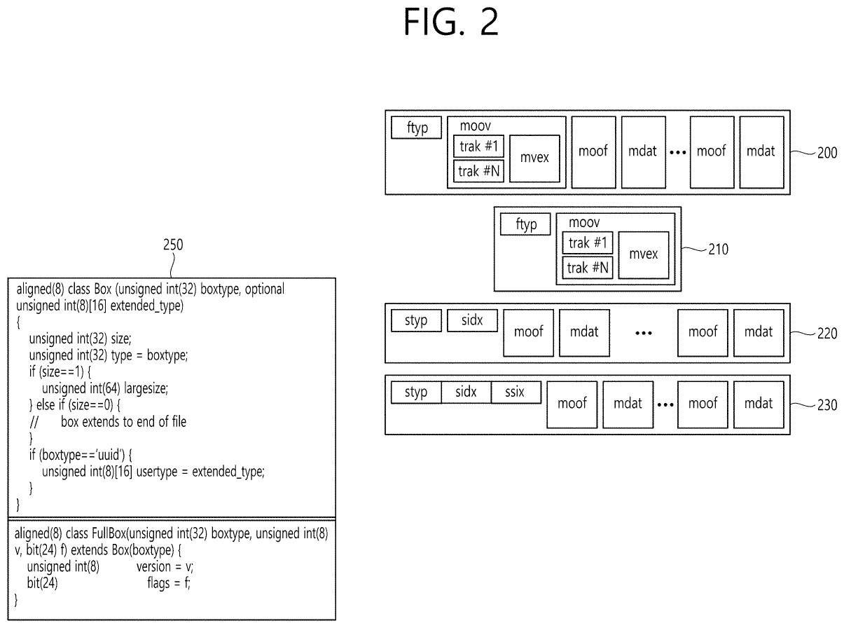

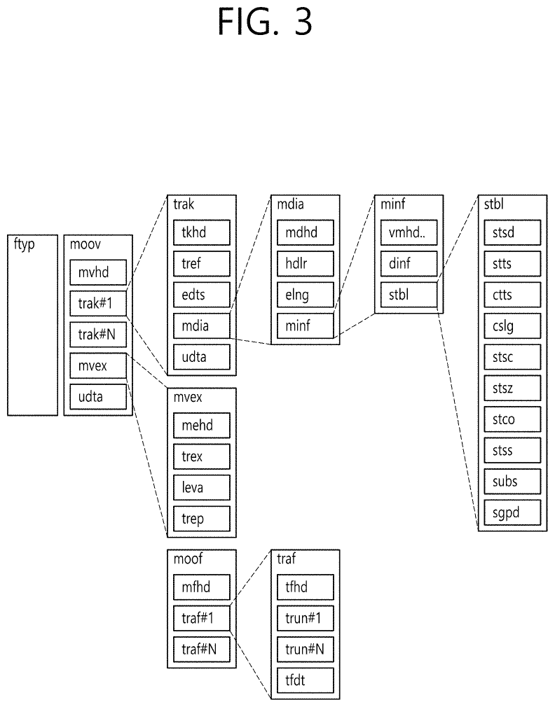

FIGS. 2 and 3 are diagrams illustrating the structure of a media file according to an embodiment of the present disclosure.

The media file according to an embodiment may include at least one box. Here, a box may be a data block or an object including media data or metadata related to media data. Boxes may be in a hierarchical structure and thus data can be classified and media files can have a format suitable for storage and/or transmission of large-capacity media data. Further, media files may have a structure which allows users to easily access media information such as moving to a specific point of media content.

The media file according to an embodiment may include an ftyp box, a moov box and/or an mdat box.

The ftyp box (file type box) can provide file type or compatibility related information about the corresponding media file. The ftyp box may include configuration version information about media data of the corresponding media file. A decoder can identify the corresponding media file with reference to ftyp box.

The moov box (movie box) may be a box including metadata about media data of the corresponding media file. The moov box may serve as a container for all metadata. The moov box may be a highest layer among boxes related to metadata. According to an embodiment, only one moov box may be present in a media file.

The mdat box (media data box) may be a box containing actual media data of the corresponding media file. Media data may include audio samples and/or video samples. The mdat box may serve as a container containing such media samples.

According to an embodiment, the aforementioned moov box may further include an mvhd box, a trak box and/or an mvex box as lower boxes.

The mvhd box (movie header box) may include information related to media presentation of media data included in the corresponding media file. That is, the mvhd box may include information such as a media generation time, change time, time standard and period of corresponding media presentation.

The trak box (track box) can provide information about a track of corresponding media data. The trak box can include information such as stream related information, presentation related information and access related information about an audio track or a video track. A plurality of trak boxes may be present depending on the number of tracks.

The trak box may further include a tkhd box (track head box) as a lower box. The tkhd box can include information about the track indicated by the trak box. The tkhd box can include information such as a generation time, a change time and a track identifier of the corresponding track.

The mvex box (movie extend box) can indicate that the corresponding media file may have a moof box which will be described later. To recognize all media samples of a specific track, moof boxes may need to be scanned.

According to an embodiment, the media file according to an embodiment may be divided into a plurality of fragments (200). Accordingly, the media file can be fragmented and stored or transmitted. Media data (mdat box) of the media file can be divided into a plurality of fragments and each fragment can include a moof box and a divided mdat box. According to an embodiment, information of the ftyp box and/or the moov box may be required to use the fragments.

The moof box (movie fragment box) can provide metadata about media data of the corresponding fragment. The moof box may be a highest-layer box among boxes related to metadata of the corresponding fragment.

The mdat box (media data box) can include actual media data as described above. The mdat box can include media samples of media data corresponding to each fragment corresponding thereto.

According to an embodiment, the aforementioned moof box may further include an mfhd box and/or a traf box as lower boxes.

The mfhd box (movie fragment header box) can include information about correlation between divided fragments. The mfhd box can indicate the order of divided media data of the corresponding fragment by including a sequence number. Further, it is possible to check whether there is missed data among divided data using the mfhd box.

The traf box (track fragment box) can include information about the corresponding track fragment. The traf box can provide metadata about a divided track fragment included in the corresponding fragment. The traf box can provide metadata such that media samples in the corresponding track fragment can be decoded/reproduced. A plurality of traf boxes may be present depending on the number of track fragments.

According to an embodiment, the aforementioned traf box may further include a tfhd box and/or a trun box as lower boxes.

The tfhd box (track fragment header box) can include header information of the corresponding track fragment. The tfhd box can provide information such as a basic sample size, a period, an offset and an identifier for media samples of the track fragment indicated by the aforementioned traf box.

The trun box (track fragment run box) can include information related to the corresponding track fragment. The trun box can include information such as a period, a size and a reproduction time for each media sample.

The aforementioned media file and fragments thereof can be processed into segments and transmitted. Segments may include an initialization segment and/or a media segment.

A file of the illustrated embodiment 210 may include information related to media decoder initialization except media data. This file may correspond to the aforementioned initialization segment, for example. The initialization segment can include the aforementioned ftyp box and/or moov box.

A file of the illustrated embodiment 220 may include the aforementioned fragment. This file may correspond to the aforementioned media segment, for example. The media segment may further include an styp box and/or an sidx box.

The styp box (segment type box) can provide information for identifying media data of a divided fragment. The styp box can serve as the aforementioned ftyp box for a divided fragment. According to an embodiment, the styp box may have the same format as the ftyp box.

The sidx box (segment index box) can provide information indicating an index of a divided fragment. Accordingly, the order of the divided fragment can be indicated.

According to an embodiment 230, an ssix box may be further included. The ssix box (sub-segment index box) can provide information indicating an index of a sub-segment when a segment is divided into sub-segments.

Boxes in a media file can include more extended information based on a box or a FullBox as shown in the illustrated embodiment 250. In the present embodiment, a size field and a largesize field can represent the length of the corresponding box in bytes. A version field can indicate the version of the corresponding box format. A type field can indicate the type or identifier of the corresponding box. A flags field can indicate a flag associated with the corresponding box.

Meanwhile, fields (properties) related to 360-degree video according to an embodiment of the present disclosure may be included in a DASH-based adaptive streaming model to be transmitted.

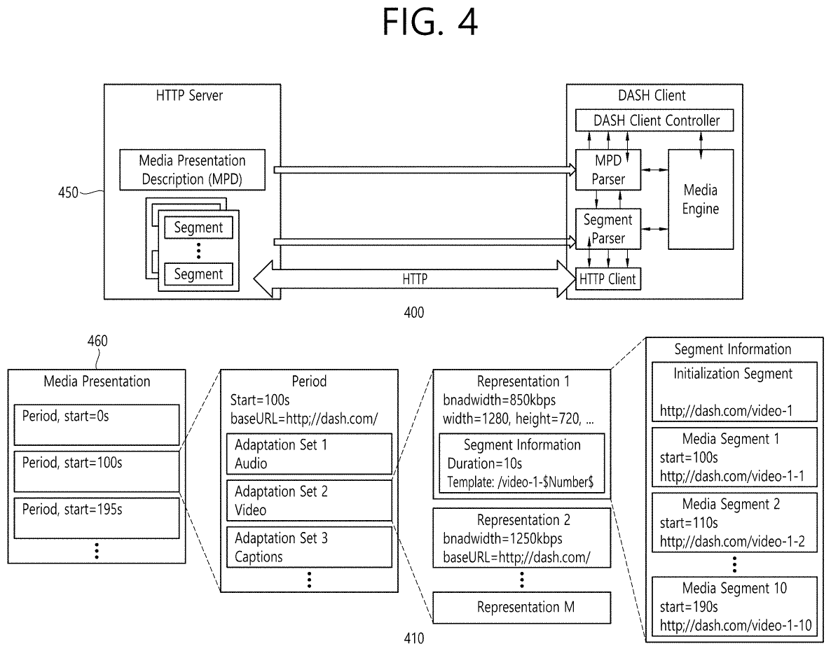

FIG. 4 is a diagram illustrating the overall operation of a DASH-based adaptive streaming model according to an embodiment of the present disclosure.

A DASH-based adaptive streaming model according to the embodiment shown in (400) describes the operation between an HTTP server and a DASH client. Here, Dynamic Adaptive Streaming over HTTP (DASH), which is a protocol for supporting HTTP-based adaptive streaming, may dynamically support streaming depending on network conditions. As a result, AV content may be reproduced without interruption.

First, the DASH client may acquire MPD. The MPD may be delivered from a service provider such as an HTTP server. The DASH client may request a segment described in the MPD from the server using information about access to the segment. Here, this request may be performed in consideration of network conditions.

After acquiring the segment, the DASH client may process the segment using a media engine, and may display the segment on a screen. The DASH client may request and acquire a necessary segment in real-time consideration of reproduction time and/or network conditions (Adaptive Streaming). As a result, content may be reproduced without interruption.

Media Presentation Description (MPD) is a file including detailed information enabling the DASH client to dynamically acquire a segment, and may be expressed in the form of XML.

A DASH client controller may generate a command for requesting MPD and/or a segment in consideration of network conditions. In addition, this controller may perform control such that the acquired information can be used in an internal block such as the media engine.

An MPD parser may parse the acquired MPD in real time. In doing so, the DASH client controller may generate a command for acquiring a necessary segment.

A segment parser may parse the acquired segment in real time. The internal block such as the media engine may perform a specific operation depending on information included in the segment.

An HTTP client may request necessary MPD and/or a necessary segment from the HTTP server. In addition, the HTTP client may deliver the MPD and/or segment acquired from the server to the MPD parser or the segment parser.

The media engine may display content using media data included in the segment. In this case, information of the MPD may be used.

A DASH data model may have a hierarchical structure (410). Media presentation may be described by the MPD. The MPD may describe the temporal sequence of a plurality of periods making media presentation. One period may indicate one section of the media content.

In one period, data may be included in adaptation sets. An adaptation set may be a set of media content components that can be exchanged with each other. Adaptation may include a set of representations. One representation may correspond to a media content component. In one representation, content may be temporally divided into a plurality of segments. This may be for appropriate access and delivery. A URL of each segment may be provided in order to access each segment.

The MPD may provide information related to media presentation. A period element, an adaptation set element, and a representation element may describe a corresponding period, adaptation set, and representation, respectively. One representation may be divided into sub-representations. A sub-representation element may describe a corresponding sub-representation.

Here, common attributes/elements may be defined. The common attributes/elements may be applied to (included in) the adaptation set, the representation, and the sub-representation. EssentialProperty and/or SupplementalProperty may be included in the common attributes/elements.

EssentialProperty may be information including elements considered to be essential to process data related to the media presentation. SupplementalProperty may be information including elements that may be used to process data related to the media presentation. In some embodiments, in the case where signaling information, a description of which will follow, is delivered through the MPD, the signaling information may be delivered while being defined in EssentialProperty and/or SupplementalProperty.

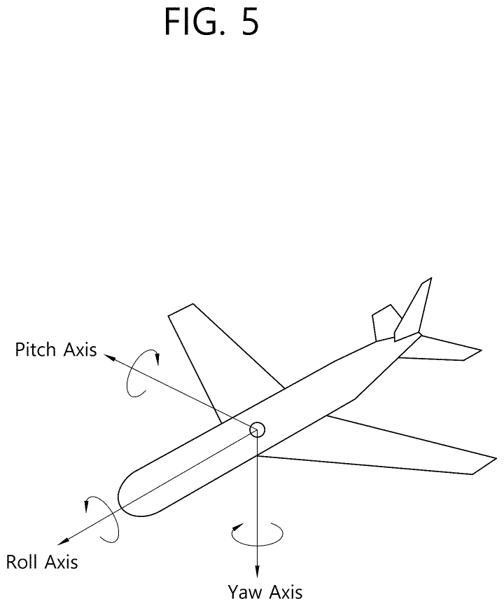

FIG. 5 is a diagram illustrating the concept of aircraft principal axes to explain a 3D space according to an embodiment.

In the present disclosure, the concept of aircraft principal axes may be used to express a specific point, position, direction, interval, region, or the like in the 3D space. That is, in the present disclosure, a 3D space before or after projection will be described, and the concept of aircraft principal axes may be used to perform signaling thereon. According to an embodiment, a method of using the concept of X-, Y-, and Z-axes or a spherical coordinate system may be used.

An aircraft may rotate freely 3-dimensionally. Axes constituting 3-dimension are respectively called a pitch axis, a yaw axis, and a roll axis. In this specification, these axes may be simply expressed by pitch, yaw, and roll, or may be expressed by a pitch direction, a yaw direction, and a roll direction.

The pitch axis may imply a reference axis of a direction in which a front nose of the aircraft rotates up/down. In the concept of a principal axis of the illustrated aircraft, the pitch axis may imply an axis which extends from wing to wing of the aircraft.

The yaw axis may imply a reference axis of a direction in which the front noise of the aircraft rotates left/right. In the concept of the principal axis of the illustrated aircraft, the yaw axis may imply an axis which extends from top to bottom of the aircraft. In the concept of the principal axis of the illustrated aircraft, the roll axis is an axis which extends from the front nose to a tail of the aircraft, and a rotation of a roll direction may imply a rotation based on the roll axis. As described above, a 3D space in the present disclosure may be described through the pitch, yaw, and roll concept.

Meanwhile, video data projected on a 2D image as described above may be subjected to region-wise packing to increase video coding efficiency. The region-wise packing process may imply a process in which the video data projected on the 2D image is processed by dividing it for each region. The region may represent a region for a divided 2D image in which 360 video data is projected, and the regions for the divided 2D image may be distinct depending on a projection scheme. Herein, the 2D image may be called a video frame or a frame.

In association therewith, the present disclosure proposes metadata for the region-wise packing process and a method of signaling the metadata. The region-wise packing process may be more efficiently performed based on the metadata.

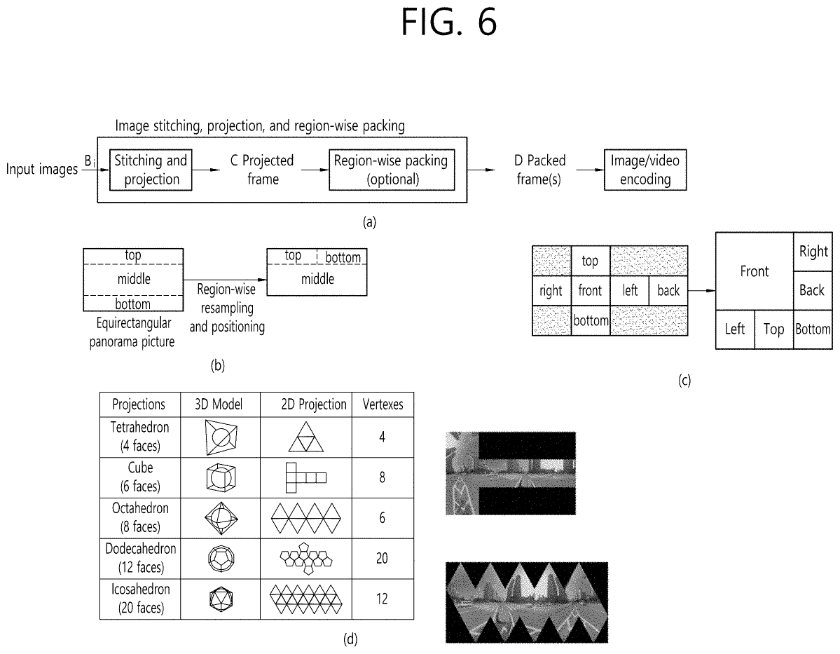

FIG. 6 exemplarily illustrates a 2D image to which a 360 video processing process and a region-wise packing process based on a projection format are applied.

The sub-figure (a) of FIG. 6 may illustrate a process of processing input 360 video data. Referring to the sub-figure (a) of FIG. 6, 360 video data at an input time may be stitched or projected to a 3D projection structure according to various projection schemes, and the 360 video data projected to the 3D projection structure may be represented as a 2D image. That is, the 360 video data may be stitched, and may be projected on the 2D image. The 2D image on which the 360 video data is projected may be represented as a projected frame. In addition, the projected frame may be subjected to the aforementioned region-wise packing process. That is, an area including the projected 360 video data on the projected frame may be divided into regions, and a process such as rotating and re-arranging each of the regions or changing resolution of each region may be performed. In other words, the region-wise packing process may represent a process of mapping the projected frame to one or more packed frames. The performing of the region-wise packing process may be optional, and if the region-wise packing process is not applied, the packed frame and the projected frame may be identical to each other. If the region-wise packing process is applied, each region of the projected frame may be mapped to a region of the packed frame, and metadata may be derived which indicates a position, shape, and size of a region of the packed frame to which each region of the projected frame is mapped.

The sub-figures (b) and (c) of FIG. 6 may illustrate examples in which each region of the projected frame is mapped to a region of the packed frame. Referring to the sub-figure (b) of FIG. 6, the 360 video data may be projected on a 2D image (or a frame) according to a panoramic projection scheme. A top region, middle region, and bottom region of the projected frame may be re-arranged as shown in the figure on the right by applying a region-wise packing process. Herein, the top region may be a region representing a top portion of the panorama on the 2D image, the middle region may be a region representing a middle portion of the panorama on the 2D image, and the bottom region may be a region representing a bottom portion of the panorama on the 2D image. In addition, referring to the sub-figure (c) of FIG. 6, the 360 video data may be projected on the 2D image (or frame) according to a cubic projection scheme. A front region, back region, top region, bottom region, right region, and left region of the projected frame may be re-arranged as shown in the figure on the right by applying the region-wise packing process. Herein, the front region may be a region representing a front portion of the cube on the 2D image, and the back region may be a region representing a back portion of the cube on the 2D image. In addition, herein, the top region may be a region representing a top portion of the cube, and the bottom region may be a region representing a bottom portion of the cube on the 2D image. In addition, the right region may be a region representing a right side portion of the cube on the 2D image, and the left region may be a region representing a left side portion of the cube on the 2D image.

The sub-figure (d) of FIG. 6 may illustrate various 3D projection formats capable of projecting the 360 video data. Referring to the sub-figure (d) of FIG. 6, the 3D projection formats may include a tetrahedron, a cube, an octahedron, a dodecahedron, and an icosahedron. 2D projections shown in the sub-figure (d) of FIG. 6 may represent projected frames in which 360 video data projected with the 3D projection format is represented as a 2D image.

The projection formats are for exemplary purposes. According to the present disclosure, the entirety or part of the following various projection formats (or projection schemes) may be used. Which projection format is used for 360 video may be indicated, for example, through a projection format field of metadata.

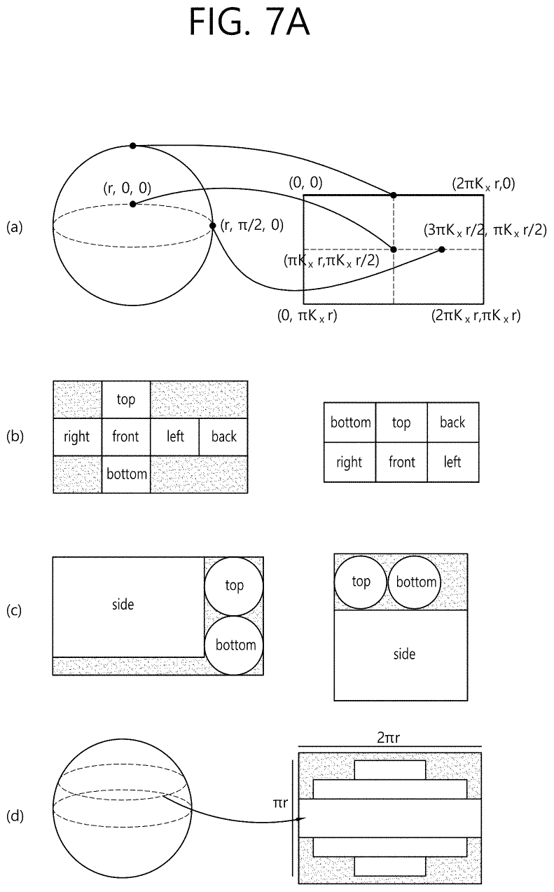

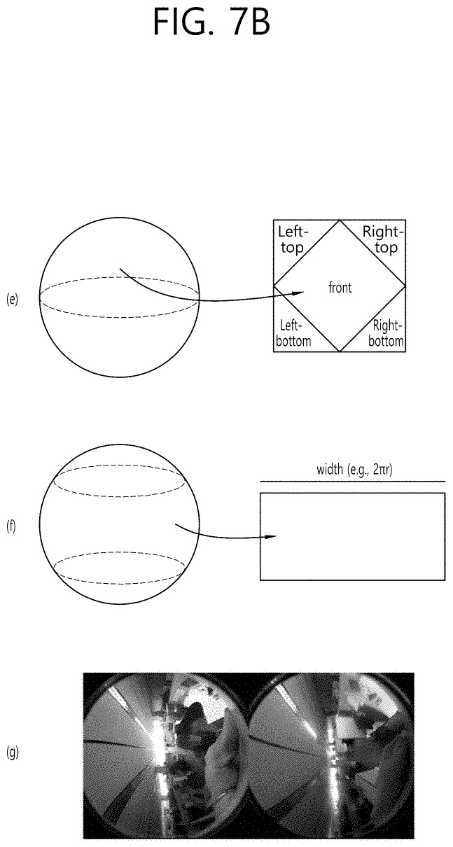

FIG. 7a and FIG. 7b exemplarily illustrate projection formats according to an embodiment.

The sub-figure (a) of FIG. 7a may illustrate an isotropic projection format. If the isotropic projection format is used, a point (r, θ₀, θ), i.e., θ=θ₀, φ=0, on a spherical surface may be mapped to a central pixel of a 2D image. In addition, a principal point of a front camera may be assumed as a point (r, 0, 0) of the spherical surface. In addition, it may be fixed as φ₀=0. Therefore, a value (x, y) converted into an XY coordinate system may be converted into a pixel (X, Y) on the 2D image through the following equation.

X=Kₓ*x+X_{O}=Kₓ*(θ−θ₀)*r+X_{O}

Y=−K_{y}*y−Y_{O} [Equation 1]

In addition, if a left top sample of the 2D image is located at (0, 0) of the XY coordinate system, an offset value for the x-axis and an offset value for the y-axis may be represented through the following equation.

X_{O}=Kₓ*π*r

Y_{O}=−K_{y}*π/2*r [Equation 2]

By using this, a conversion equation for the XY coordinate system may be re-written as follows.

X=Kₓx+X_{O}=Kₓ*(π+θ−θ₀)*r

Y=−K_{y}y−Y_{O}=K_{y}*(π/2−φ)*r [Equation 3]

For example, if θ₀=0, that is, if a center pixel of a 2D image indicates data of 0=0 on a spherical surface, the spherical surface may be mapped to an area having a width=2Kₓπr and a height=Kₓπr on the 2D image with respect to (0,0). On the spherical surface, data of φ=π/2 may be mapped to the entirety of an upper side on the 2D image. In addition, on the spherical surface, data of (r, π/2, 0) may be mapped to a point (3πKₓr/2, πKₓr/2) on the 2D image.

In a reception side, 360 video data on the 2D image may be re-projected on the spherical surface. This may be written as a conversion equation as follows.

θ=θ₀+X/Kₓ*r−π

φ=π/2−Y/K_{y}*r [Equation 4]

For example, a pixel having an XY coordinate value of (Kₓπr, 0) on the 2D image may be re-projected on a point of θ=θ₀, φ=π/2 on the spherical surface.

The sub-figure FIG. 7a may illustrate a cubic projection format. For example, stitched 360 video data may be represented on a spherical surface. A projection processor may divide the 360 video data into a cube shape and then may project it on a 2D image. The 360 video data on the spherical surface may correspond to each face of the cube, and thus may be projected on the 2D image as shown in the left side in the sub-figure (b) of FIG. 7a or in the right side in the sub-figure (b).

The sub-figure (c) of FIG. 7a may illustrate a cylindrical projection format. Assuming that stitched 360 video data can be represented on a spherical surface, a projection processor may divide 360 video data into a cylinder shape and then may project it on a 2D image. The 360 video data on the spherical surface may correspond to each of a side, top, and bottom of a cylinder, and thus may be projected on the 2D image as shown in the left side in the sub-figure (c) of FIG. 7a or in the right-side in the sub-figure (c).

The sub-figure (d) of FIG. 7a may illustrate a tile-based projection format. In case of using a tile-based projection scheme, the aforementioned projection processor may divide project 360 video data into one or more sub-areas as shown in the sub-figure (d) of FIG. 7a and then may project it on a spherical surface on a 2D image. The sub-area may be called a tile.

The sub-figure (e) of FIG. 7b may illustrate a pyramid projection format. Assuming that stitched 360 video data can be represented on a spherical surface, a projection processor may divide 360 video data into a pyramid shape and then may project it on a 2D image. The 360 video data on the spherical surface may correspond to each of a front face of the pyramid and four directional sides (left top, left bottom, right top, right bottom) of the pyramid, and thus may be projected on the 2D image as shown in the left side in the sub-figure (e) of FIG. 7b or in the right side in the sub-figure (e). Herein, the front face may be an area including data obtained by a camera facing a front face.

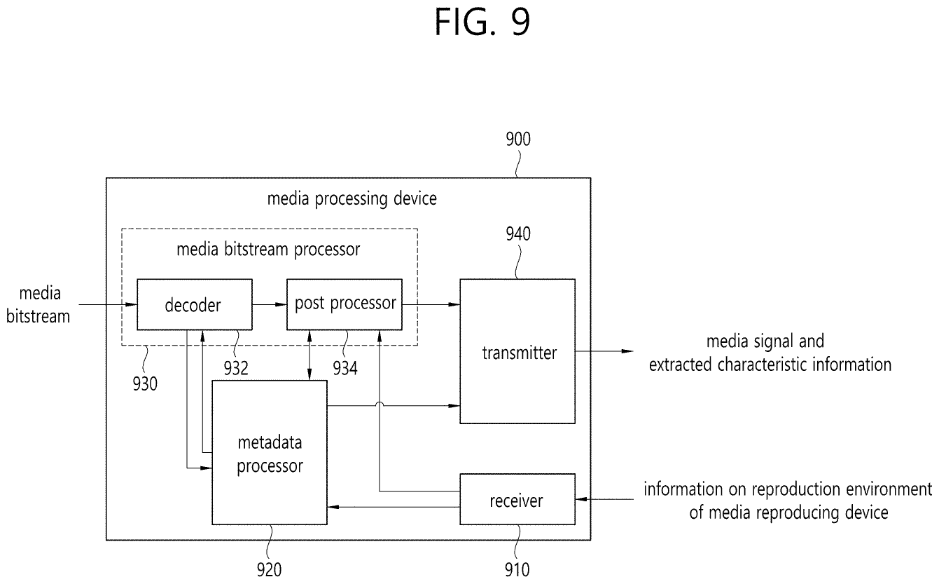

The sub-figure (f) of FIG. 7b may illustrate a panoramic projection format. In case of using a panoramic projection format, the aforementioned projection processor may project only a side face of 360 video data on a spherical surface on a 2D image as shown in the sub-figure (f) of FIG. 9b. This may be the same as a case where a top face and a bottom face do not exist in the cylindrical projection scheme.

Meanwhile, according to an embodiment of the present disclosure, a projection may be performed without stitching. The sub-figure (g) of FIG. 7b may illustrate a case where a projection is performed without stitching. If the projection is performed without stitching, the aforementioned projection processor may project 360 video data directly on a 2D image as shown in the sub-figure (g) of FIG. 7b. In this case, each of images obtained by a camera may be directly projected on the 2D image without performing stitching.

Referring to the sub-figure (g) of FIG. 7b, two images may be projected on a 2D image without stitching. Each image may be a fish-eye image obtained through each sensor of a spherical camera (or a fish-eye camera). As described above, image data obtained from camera sensors may be stitched in a reception side, and the stitched image data may be mapped on a spherical surface to render a spherical video, i.e., 360 video.

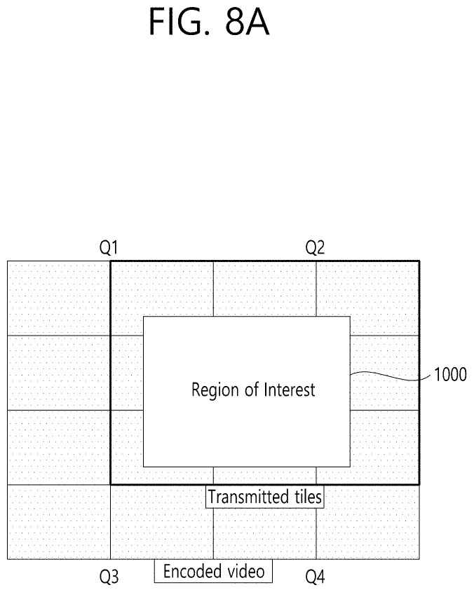

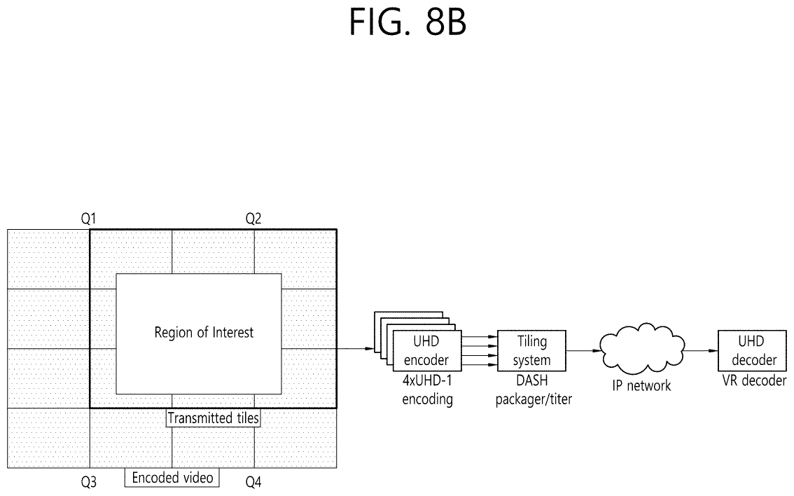

FIG. 8a and FIG. 8b illustrate a tile according to an embodiment.

360 video data projected on a 2D image or 360 video data subjected to up to region-wise packing may be divided into one or more tiles. FIG. 8a illustrates a shape in which one 2D image is divided into 16 tiles. Herein, the 2D image may be the aforementioned projected frame or packed frame. According to another embodiment of a 360 video transmission device according to the present disclosure, a data encoder may independently encode each tile.

The aforementioned region-wise packing and tiling may be distinct from each other. The aforementioned region-wise packing may imply processing of 360 video data projected on a 2D image by dividing it in a region-wise manner to improve coding efficiency or to adjust resolution. The tiling may imply that a data encoder divides a projected frame or a packed frame into sections called a tile, and independently performs encoding for each tile. When 360 video is provided, a user does not consume all parts of 360 video at the same time. The tiling may enable transmitting or consuming of only a tile corresponding to an important part or a specific part, such as a viewport currently viewed by the user, on a limited bandwidth. The tiling may allow more efficient utilization of the limited bandwidth, and may reduce a computational load in a reception side, compared with processing of all 360 video data at a time.

Since a region and a tile are distinct from each other, the two areas are not necessarily the same. However, according to an embodiment, the region and the tile may refer to the same area. According to an embodiment, region-wise packing may be performed based on a tile so that a region is the same as the tile. In addition, according to an embodiment, if each face based on a projection scheme is the same as the region, each face, region, and tile based on the projection scheme may refer to the same area. According to context, the region may also be called a VR region, and the tile may also be called a tile region.

Region of interest (ROI) may imply an interested region of users, proposed by a 360 content provider. When 360 video is produced, the 360 content provider regards that the users will be interested in a specific region and produce the 360 video by considering this. According to an embodiment, the ROI may correspond to an area in which important content is reproduced, on content of the 360 video.

According to another embodiment of a 360 video transmission/reception device based on the present disclosure, a reception-side feedback processor may extract and collect viewport information, and may transfer it to a transmission-side feedback processor. In this process, the viewport information may be transferred by using network interfaces of the both sides. A viewport 1000 is indicated in a 2D image of FIG. 8a. Herein, the viewport may exist across 9 tiles on the 2D image.

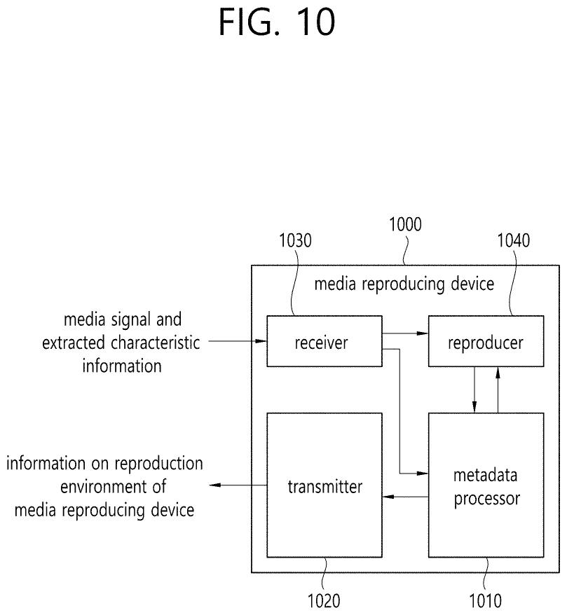

In this case, the 360 video transmission device may further include a tiling system. According to an embodiment, the tiling system may be located next to a data encoder (shown in FIG. 10b), may be included in the aforementioned data encoder or transmission processor, or may be included in the 360 video transmission device as a separate internal/external element.

The tiling system may receive the viewport information transferred from the transmission-side feedback processor. The tiling system may select and transmit only a tile in which a viewport area is included. In the 2D image shown in FIG. 8a, only 9 tiles including the viewport area 1000 may be transmitted out of 16 tiles in total. Herein, the tiling system may transmit tiles in a unicast manner through a broadband. This is because a viewport area varies depending on a user.

In addition, in this case, the transmission-side feedback processor may transfer the viewport information to the data encoder. For tiles including the viewport area, the data encoder may perform encoding with higher quality than other tiles.

In addition, in this case, the transmission-side feedback processor may transfer the viewport information to the metadata processor. The metadata processor may transfer metadata related to the viewport area to each internal element of the 360 video transmission device, or may include it to metadata related to the 360 video.

Through this tiling scheme, a transmission bandwidth may be saved, and effective data processing/transmission may be possible by performing a process differentiated for each tile.

Embodiments related to the aforementioned viewport area may also similarly apply to different specific areas other than the viewport area. For example, processes the same as those performed for the aforementioned viewport area may also be performed for an area determined as a main interested area of users through the aforementioned gaze analysis, an ROI area, an area (an initial viewpoint) reproduced when the user encounters 360 video through a VR display, or the like.

According to another embodiment of the 360 video transmission device based on the present disclosure, the transmission processor may perform a process for transmission differently for each tile. The transmission processor may apply a different transmission parameter (a modulation order, a code rate, etc.) for each tile, so that robustness of data transferred to each tile is different.

In this case, the transmission-side feedback processor may transfer, to the transmission processor, feedback information transferred from the 360 video reception device, so that the transmission processor performs a transmission process differentiated for each tile. For example, the transmission-side feedback processor may transfer, to the transmission processor, viewport information transferred from the reception side. The transmission processor may perform a transmission process so that tiles including a corresponding viewport area have higher robustness than other tiles.

Meanwhile, the aforementioned 360 video-related metadata may include a variety of metadata for 360 video. The 360 video-related metadata may also be called 360 video-related signaling information. The 360 video-related metadata may be transmitted by being included in a separate signaling table, or may be transmitted by being included in DASH MPD, or may be transferred by being included in a box form in a file format such as ISOBMFF or the like. If the 360 video-related metadata is included in the box form, various levels such as a file, a fragment, a track, a sample entry, a sample, or the like are included, and thus metadata for data of a corresponding level may be included. According to an embodiment, a part of metadata described below may be transferred by being configured in a signaling table, and the remaining parts may be included in a box or track form in a file format. According to an embodiment of 360 video-related metadata based on the present disclosure, the 360 video-related metadata may include basic metadata regarding a projection format or the like, stereoscopic-related metadata, initial view/initial viewpoint-related metadata, ROI-related metadata, field of view (FOV)-related metadata, and/or cropped region-related metadata. According to an embodiment, the 360 video-related metadata may further include additional metadata in addition to the aforementioned metadata. Embodiments of the 360 video-related metadata based on the present disclosure may have a form including at least one of the aforementioned basic metadata, stereoscopic-related metadata, initial view/initial viewpoint-related metadata, ROI-related metadata, FOV-related metadata, cropped region-related metadata, and/or metadata to be added at a later time. Each of embodiments of the 360 video-related metadata based on the present disclosure may be configured variously according to the number of cases of detailed metadata included therein. According to an embodiment, the 360 video-related metadata may further include additional information in addition to the aforementioned metadata.

FIG. 9 is a block diagram illustrating a structure of a media processing device according to an embodiment.

In the present specification, a “media processing device” 900 may imply a device for performing media signal processing. Examples of the device include a setup box (STB), a Blu-ray, a DVD player, a PC, or the like, but are not limited thereto. Media signal processing may imply, for example, decoding of a media bitstream, post-processing or rendering of a decoded media bitstream, or the like, but are not limited thereto.

Since the media processing device 900 may perform media signal processing while transmitting/receiving media data with respect to a media reproducing device, the media processing device 900 and the media reproducing device may be respectively called a source device and a sink device. Detailed descriptions on the media reproducing device will be described below with reference to FIG. 10.

As shown in FIG. 9, the media processing device 900 according to an embodiment may include a receiver 910, a metadata processor 920, a media bitstream processor 930, and a transmitter 940. However, not all constitutional elements of FIG. 9 are necessary constitutional elements of the media processing device 900. The number of constitutional elements used to implement the media processing device 900 may be greater than or less than the number of constitutional elements of FIG. 9. For example, the media processing device 900 according to an embodiment may additionally include a media option device controller (not shown in the figure).

The receiver 910 according to an embodiment may receive information on reproduction environment of the media reproducing device from the media reproducing device. The information on reproduction environment may indicate at least one of information on a status of the media reproducing device and information on reproduction capability. In an embodiment according to the present disclosure, in particular, the information on reproduction environment may imply information on 3D reproduction environment. More specifically, in an embodiment according to the present disclosure, the information on reproduction environment may include at least one of virtual reality (VR) reproduction environment information and augmented reality (AR) reproduction environment information.

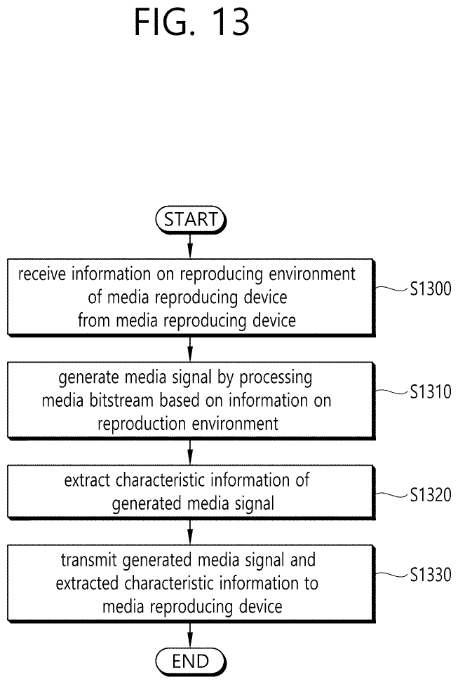

The information on reproduction environment may include at least one of extended display identification data standard (EDID), EDID extension, and DisplayID. Optionally, the information on reproduction environment may directly imply at least one of EDID, EDID extension, and DisplayID. At least one of EDID, EDID extension, and DisplayID may include, for example, a sampling rate of a media signal, information related to corresponding and coding (a compression scheme, a compression rate, etc.), information on 3D media data, or the like. Detailed information that can be included in at least one of EDID, EDID extension, and DisplayID will be described below with reference to FIG. 13.

The metadata processor 920 according to an embodiment may read the information on reproduction environment of the media reproducing device, transferred from the receiver 910. The metadata processor 920 may transfer the information on reproduction environment of the media reproducing device to the media bitstream processor 930, so that the media bitstream processor 930 can use the information on reproduction environment of the media reproducing device in a process of generating a media signal by processing the media bitstream. More specifically, the metadata processor 920 may transfer the information on reproduction environment of the media reproducing device to a decoder 932, so that the decoder 932 can use the information on reproduction environment of the media reproducing device in a process of decoding a 3D media bitstream.

In this case, the media bitstream may be transferred to the media processing device 900 (more specifically, the media bitstream processor 930) through the network, or may be transferred from a digital storage medium to the media processing device 900. Herein, the network may include a broadcasting network and/or a communication network, and the digital storage medium may include various storage media such as a universal serial bus (USB), an SD, a compact disc (CD), a digital versatile disc (DVD), a Blu-ray, a hard disk drive (HDD), a solid state drive (SSD), or the like.

In addition, the metadata processor 920 may extract characteristic information of the media signal generated by processing the media bitstream in the media bitstream processor 930. The characteristic information of the media signal may include, for example, InfoFrame. Detailed descriptions on the InfoFrame will be described below with reference to FIG. 13.

Meanwhile, although not shown in FIG. 9, the media processing device 900 according to an embodiment may further include a media option controller. The media option controller according to an embodiment may receive the information on reproduction environment of the media reproducing device, transferred from the metadata processor 920, and may determine whether to perform post-processing on a media signal decoded in the decoder 932 on the basis of the transferred information on reproduction environment.

If the media signal decoded in the decoder 932 can be reproduced in the media reproducing device without having to perform an additional process, the media option controller may determine not to perform post-processing on the media signal decoded in the decoder 932. In this case, the media option controller may transmit to a post-processing module 934 a signal for controlling the post-processing module 934 not to perform post-processing on the media signal decoded in the decoder 932, and may transmit information indicating that the post-processing is not performed to the media reproducing device via the transmitter 940.

On the contrary, if the post-processing is possible in the media processing device 900 on the basis of a user setting and if the media reproducing device can reproduce a post-processed media signal, the media option controller may determine to perform the post-processing on the media signal decoded in the decoder 932. In this case, the media option controller may transfer to the post-processing module 934 a signal for controlling the post-processing module 934 to perform post-processing on the media signal decoded in the decoder 932, and may transmit information indicating that the post-processing is performed to the media reproducing device via the transmitter 940.

The bitstream processor 930 according to an embodiment may generate a media signal by processing the media bitstream on the basis of the information on reproduction environment of the media reproducing device. The media bitstream processor 930 may include the decoder 932 and the post-processing module 934. However, not all constitutional elements of FIG. 9 are necessary constitutional elements of the media bitstream processor 930. The number of constitutional elements used to implement the media bitstream processor 930 may be greater than or less than the number of constitutional elements of FIG. 9.

For example, although not shown in FIG. 9, the media bitstream processor 930 may additionally include a renderer. The renderer may render the decoded media stream.

In another example, although not shown in FIG. 9, the media bitstream processor 930 may additionally include an equalizer. If the information on reproduction environment of the media reproducing device includes room information or room environment of the media reproducing device, the equalizer may perform equalization on a media signal transferred from the renderer, thereby improving quality of audio reproduced in the media reproducing device, e.g., a speaker.

The decoder 932 according to an embodiment may decode the media bitstream. More specifically, the decoder 932 may decode the media bitstream on the basis of the information on reproduction environment. In this case, the information on reproduction environment may be transferred to the decoder 932 via the metadata processor 920, but this is for exemplary purposes only. For example, the information on reproduction environment may be transferred to the decoder 932 via the receiver 910 or the media option controller.

The post-processing module 934 according to an embodiment may post-process the media signal decoded in the decoder 932. The post-processing module 934 may post-process the media signal decoded in the decoder 932 on the basis of the information on reproduction environment, received from the media reproducing device, a user setting, or the like, but the embodiment is not limited thereto. For example, even if there is no additional information for media processing, the post-processing module 934 may autonomously improve image quality of media. The post-processing module 934 may receive the information on reproduction environment, transferred from the media option controller, the metadata processor 920, or the receiver 910.

The post-processing module 934 may operate based on a control signal received from a media option setting module. More specifically, the post-processing module 934 may determine whether to perform post-processing according to the control signal transferred from the media option setting module, and may transmit to the transmitter 940 a media signal subjected to post-processing or a media signal not subjected to post-processing on the basis of the determination.

The transmitter 940 according to an embodiment may transmit, to the media reproducing device, characteristic information of a media signal generated in the media bitstream processor 930 and a media signal extracted from the metadata processor 920. The transmitter 940 may transmit the characteristic information of the media signal generated in the media bitstream processor 930 and the media signal extracted from the metadata processor 920 simultaneously to the media reproducing device, or may transmit it with a pre-set time difference. Alternatively, the transmitter 940 may transmit to the media reproducing device the media signal after an audio signal is generated from the media bitstream processor 930 and a pre-set time elapses, and may transmit to the media reproducing device the characteristic information of the media signal after the characteristic information of the media signal is extracted in the metadata processor 920 and a pre-set time elapses. As such, a time point at which the media signal and characteristic information of the media processing device 900 are transmitted to the media reproducing device can be variously defined, which will be easily understood by those ordinarily skilled in the art.

According to the media processing device 900 described with reference to FIG. 9, a 3D media signal may be generated by processing a media bitstream on the basis of at least one of 3D reproduction environment information of the media reproducing device, received from the media reproducing device, that is, at least one of VR reproduction environment information and AR reproduction environment information, may extract characteristic information of the generated VR or AR media signal, and may transmit the generated VR or AR audio signal and the extracted characteristic information to the media reproducing device. That is, the media processing device 900 may generate the VR or AR media signal so that the media reproducing device can more smoothly reproduce the VR or AR media content while transmitting/receiving VR or AR media data with respect to the media reproducing device.

In addition, according to the media processing device 900 described with reference to FIG. 9, since at least one of EDID, EDID extension, Display ID, and InfoFrame transmitted by the media processing device 900 and the media reproducing device is defined in an extended manner to provide a VR or AR service, the media reproducing device may more smoothly reproduce VR or AR media content.

FIG. 10 is a block diagram illustrating a structure of a media reproducing device according to an embodiment.

In the present specification, a “media reproducing device” 1000 may imply a device which reproduces media signal. Examples of the device may include an HMD, a headphone, an earphone, a tablet, an AR glass, other devices capable of receiving VR or AR content, or the like, but the device is not limited thereto. The media reproducing device 1000 may reproduce a media signal received from a media processing device 900 which transmits/receives media data with respect to the media reproducing device 1000, but a method in which the media reproducing device 1000 reproduces media is not limited thereto.

As shown in FIG. 10, the media reproducing device 1000 according to an embodiment may include a metadata processor 1010, a transmitter 1020, a receiver 1030, and a reproducer 1040. However, not all constitutional elements of FIG. 10 are necessary constitutional elements of the media reproducing device 1000. The number of constitutional elements used to implement the media reproducing device 1000 may be greater than or less than the number of constitutional elements of FIG. 10. For example, the media reproducing device 1000 according to an embodiment may additionally include a media processing device controller (not shown in the figure).

In the media reproducing device 1000 according to an embodiment, the metadata processor 1010, the transmitter 1020, the receiver 1030, and the reproducer 1040 may be implemented as separate chips, or at least two constitutional elements may be implemented through one chip.

The metadata processor 1010 according to an embodiment may collect information on reproduction environment of the media reproducing device 1000. For example, the metadata processor 1010 may collect the information on reproduction environment of the media reproducing device 1000, stored in a memory (or a storage unit, not shown in FIG. 1) of the media reproducing device 1000.

The transmitter 1020 according to an embodiment may transmit the information on reproduction environment of the media reproducing device 1000, transferred from the metadata processor 1010, to the media processing device 900.

As described above with reference to FIG. 9, the media processing device 900 may generate a media signal by processing a media bitstream based on the information on reproduction environment of the media reproducing device 1000, and may extract characteristic information from the generated media signal. The receiver 1030 of the media reproducing device 1000 according to an embodiment may receive the generated media signal and the extracted characteristic information from the media processing device 900. The receiver 1030 may transfer the received media signal and characteristic information to the metadata processor 1010, but the embodiment is not limited thereto. For example, the receiver 1030 may transfer the received media signal to the reproducer 1040, and may transfer the received characteristic information to the metadata processor 1010.

The media signal received by the receiver 1030 of the media reproducing device 1000 according to an embodiment from the media processing device 900 may be either a compressed signal or an uncompressed signal. If the received media signal is the uncompressed signal, the receiver 1030 may directly transfer the received media signal to at least one of the metadata processor 1010 and the reproducer 1040. If the received audio signal is the compressed signal, the receiver 1030 may decode the received media signal and then transfer it to at least one of the metadata processor 1010 and the reproducer 1040. In this case, decoding of the compressed signal may be performed by the receiver 1030, or may be performed by a separate decoder.

The reproducer 1040 according to an embodiment may reproduce the received media signal, based on the extracted characteristic information of the media signal. More specifically, the extracted characteristic information of the media signal may be read from the metadata processor 1010, information obtained by reading the extracted characteristic information may be transferred from the metadata processor 1010 to the producer 1040, and the reproducer 1040 may reproduce the received media signal, based on information obtained by reading the extracted characteristic information. The reproducer 1040 may transfer to the metadata processor 1010 the information obtained while reproducing the media signal received from the media processing device 900.

Meanwhile, as described above with reference to FIG. 9, the media processing device 900 according to an embodiment may further include a media option controller, and the media option controller may determine whether post-processing will be performed on the media signal on the basis of the information on reproduction environment. In this case, the media processing device controller (not shown in the figure) included in the media reproducing device 1000 may generate a media processing device control signal on the basis of information regarding which kind of video/audio is possible in the media processing device 900, and may transfer it to the media processing device 900. However, without being limited thereto, for example, the media processing device controller may transfer a default signal to the media processing device 900, or may transfer no signal.

In addition, the media processing device controller according to an embodiment may transfer user setting information on the media reproduction environment, obtained from a user, to the transmitter 1020 of the media reproducing device 1000, and the transmitter 1020 may transmit the setting information on the media reproduction environment to the media processing device 900. The receiver 910 of the media processing device 900 may receive the setting information on the media reproduction environment and transfer it to a media option controller. The media option controller according to an embodiment may transfer the information on the media reproduction environment to the metadata processor 920 or the media bitstream processor 930.

In addition, the media processing device controller of the media reproducing device 1000 may receive at least one of a signal for controlling the post-processing module 934 to perform post-processing, a signal for controlling the post-processing module 934 not to perform post-processing, information indicating that post-processing is performed, information indicating that post-processing is not performed, and a post-processed media signal from the media option controller of the media processing device 900 described above with reference to FIG. 9.

In addition, the media processing device controller may determine whether media data transferred from the media processing device 900 is properly processed to be reproduced in the reproducer 1040, and may generate a media processing device control signal on the basis of a determination result. For example if the media data is not properly processed, the media processing device controller may determine a problematic portion during media processing of the media processing device 900 and may deactivate (or off) a function thereof.

Alternatively, the media processing device controller may activate (or on)/deactivate (or off) the problematic portion during media processing of the media processing device 900, based on a user's request. To this end, the media reproducing device 1000 may provide the user with a media processing option which is being processed or can be processed in the media processing device 900 on the basis of a menu/user interface (UI).

Alternatively, if the media reproducing device 1000 has a self-processing function, the metadata processor 1010 of the media reproducing device 1000 may analyze at least one of characteristic information and a media signal received from the media processing device 900, and thereafter may transfer an analysis result to a display panel controller (not shown in the figure). The display panel controller may provide a reproduction environment suitable for media content by adjusting a display on the basis of the analysis result transferred from the metadata processor 1010. In this case, the self-processing function of the media reproducing device 1000 may include, for example, self-processing of adjusting screen brightness and color, adjusting a distance between eyes, or the like.

According to the media reproducing device 1000 described with reference to FIG. 10, information on reproduction environment including information on 3D media reproduction of the media reproducing device 1000 may be transmitted to the media processing device 900, and a 3D media signal generated by the media processing device 900 and characteristic information extracted from the media signal may be received from the media processing device 900 on the basis of the information on reproduction environment. That is, the media reproducing device 1000 may more smoothly reproduce 3D media content according to the 3D media reproduction environment of the media reproducing device 1000, while transmitting/receiving 3D media data with respect to the media processing device 900.

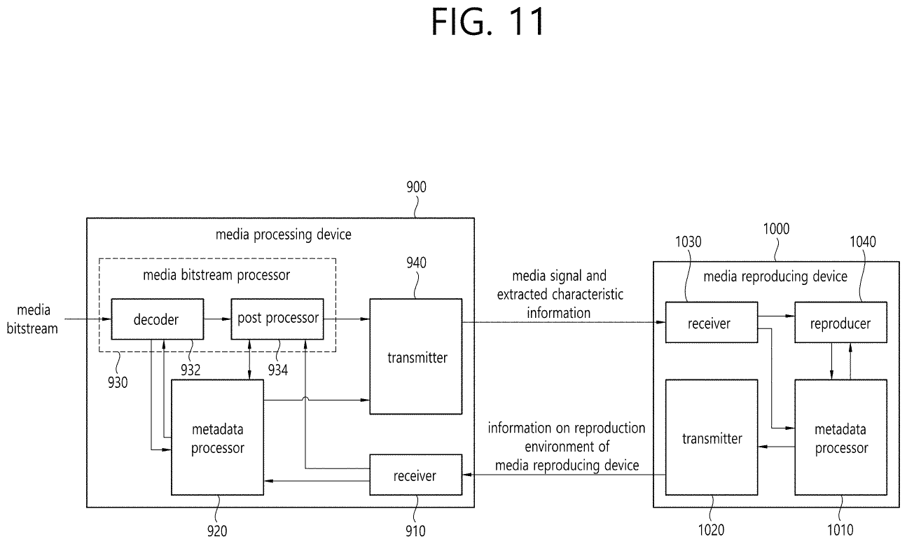

FIG. 11 is a block diagram illustrating a structure of a media processing device and media reproducing device according to an embodiment.

As shown in FIG. 11, a media processing device 900 according to an embodiment may include a receiver 910, a metadata processor 920, a media bitstream processor 930, and a transmitter 940, and a media reproducing device 1000 according to an embodiment may include a metadata processor 1010, a transmitter 1020, a receiver 1030, and a reproducer 1040.

The media processing device 900 and media reproducing device 1000 of FIG. 11 may operate in the same manner as the media processing device 900 of FIG. 9 and the media reproducing device 1000 FIG. 10, respectively, which will be easily understood by those who ordinarily skilled in the art. Therefore, hereinafter, regarding the receiver 910, metadata processor 920, media bitstream processor 930, and transmitter 940 of the media processing device 900 and the metadata processor 1010, transmitter 1020, receiver 1030, and reproducer 1040 of the media reproducing device 1000, redundant content described with reference to FIG. 9 and FIG. 10 will be omitted or simply described.

The media processing device 900 and media reproducing device 1000 according to an embodiment may be connected to each other through a wired interface. For example, the media processing device 900 and the media reproducing device 1000 may be connected to each other through a high-definition multimedia interface (HDMI) or Displayport. However, the embodiment is not limited thereto. Therefore, for example, the media processing device 900 and the media reproducing device 1000 may be connected to each other by means of another wired interface or the like other than the wired interface, the HDMI, and the Displayport. In addition, the media processing device 900 and the media reproducing device 1000 may transmit information to each other through a USB.

Examples of a transmission/reception standard of the HDMI or Displayport may include a CTA-861-G and DisplayID (Display Identification Data) standard. The media processing device 900 and media reproducing device 1000 according to an embodiment may transmit/receive media data to each other, based on the CTA-861-G or DisplayID standard of the HDMI or Displayport, and in particular may transmit/receive 3D media data to each other to implement VR or AR content. The 3D media data may be transferred from the media reproducing device 1000 to the media processing device 900 by being included in information on reproduction environment of the media reproducing device 1000, or may be transferred from the media processing device 900 to the media reproducing device 1000 by being included in information extracted from a media signal.

For example, the 3D media data may be transferred from the media reproducing device 1000 to the media processing device 900, by being included in EDID defined in video electronics standards association (VESA) or an extended data block of CTA EDID extension defined by extending the EDID, or by being included in DisplayID defined in the VESA.

By transmitting/receiving the 3D media data to each other, the media processing device 900 and media reproducing device 1000 according to an embodiment may smoothly provide a user with VR media or AR media under a VR system or an AR system.

The metadata processor 1010 of the media reproducing device 1000 according to an embodiment may collect the information on reproduction environment of the media reproducing device 1000.

The transmitter 1020 of the media reproducing device 1000 according to an embodiment may transmit the information on reproduction environment of the media reproducing device 1000 to the media processing device 900.

The receiver 910 of the media processing device 900 may receive the information on reproduction environment of the media reproducing device 1000 from the media reproducing device 1000. For example, the receiver 910 of the media processing device 900 may receive the information on reproduction environment of the media reproducing device 1000 from the media reproducing device 1000 through a display data channel (DDC). The information on reproduction environment of the media reproducing device 1000, transferred to the media processing device 900, may be stored in the media processing device 900 for a specific period so as to be used when necessary, and optionally, may be used by being occasionally received from the media reproducing device 1000 by the media processing device 900 without having to be stored in the media processing device 900.

The metadata processor 920 of the media processing device 900 according to an embodiment may receive the information on reproduction environment of the media reproducing device 1000 from the receiver 910, and may read the transferred information on reproduction environment of the media reproducing device 1000. The metadata processor 1020 may transfer the information on reproduction environment of the media reproducing device 1000 to the media bitstream processor 1030, so that the media bitstream processor 1030 can use the information on reproduction environment of the media reproducing device 1000 in a process of generating a media signal by processing the media bitstream. In addition, the metadata processor 920 may extract characteristic information from a media signal generated by processing a media bitstream in the media bitstream processor 930.

The media bitstream processor 930 of the media processing device 900 according to an embodiment may generate the media signal by processing the media bitstream on the basis of the information on reproduction environment of the media reproducing device 1000. More specifically, the media bitstream may include a VR media stream or an AR media stream, and the media bitstream processor 930 may generate a 3D media signal by processing at least one of the VR media bitstream and the AR media bitstream on the basis of the information on reproduction environment of the media reproducing device 1000.

The transmitter 940 of the media processing device 900 according to an embodiment may transmit, to the media reproducing device 1000, characteristic information of a media signal generated in the media bitstream processor 930 and a media signal extracted from the metadata processor 920.

The receiver 1030 of the media reproducing device 1000 according to an embodiment may receive the media signal and the extracted characteristic information from the media processing device 900. The receiver 1030 may transfer the received media signal and the extracted characteristic information to the metadata processor 1010.

The media reproducing device 1000 according to an embodiment may read the extracted characteristic information. The media signal and information obtained by reading the characteristic information may be transmitted from the metadata processor 1010 to the reproducer 1040. The reproducer 1040 may reproduce the received media signal, based on the information obtained by reading the characteristic information.

Although not shown in FIG. 11, the media processing device 900 according to an embodiment may include a media option controller, and the media reproducing device 1000 according to an embodiment may include a media processing device controller. The media option controller and the media processing device controller have been described above in detail with reference to FIG. 9 and FIG. 10.

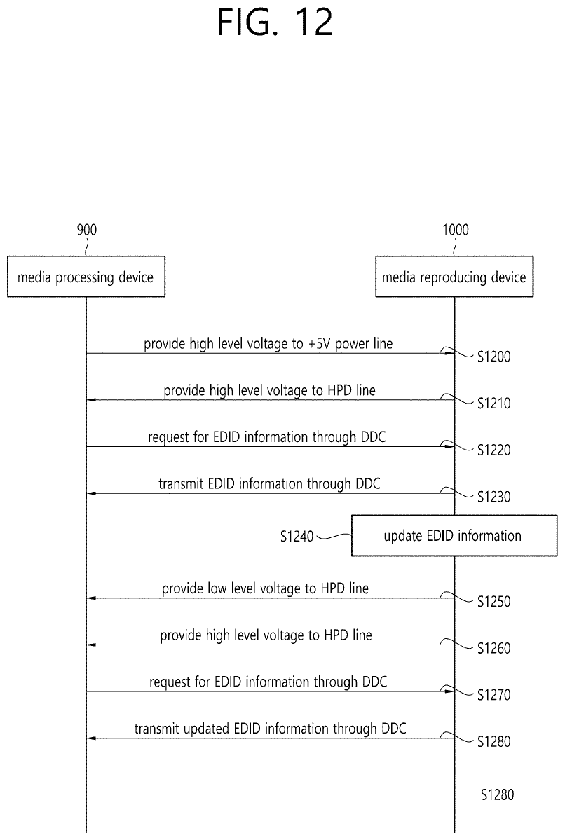

FIG. 12 is a flowchart illustrating a process in which a media reproducing device transmits EDID information to a media processing device according to an embodiment.

In a process shown in FIG. 12, when the media processing device 900 and the media reproducing device 1000 are connected to each other through a wired interface (e.g., HDMI or Display Port), the media processing device 900 and the media reproducing device 1000 transmit/receive EDID-related information and the media reproducing device 1000 transmits updated EDID information to the media processing device 900.

In an embodiment, exchanging of EDID information between the media processing device 900 and the media reproducing device 1000 according to FIG. 12 may be referred to as a source-sink handshake process. The source-sink handshake process corresponds to an operation of a time point at which the media processing device 900 and the media reproducing device 1000 are connected. Therefore, in a process in which the media reproducing device 1000 reproduces media data after an initial time point at which the two devices are connected, instead of the source-sink handshake, signals may be exchanged between the media processing device 900 and the media reproducing device 1000 at a time of changing media content or at a time of changing a specific scene.

When the media processing device 900 is connected to the media reproducing device 1000 through a wired interface, the media processing device 900 may provide high-level voltage to a +5V power line of the wired interface with respect to the media reproducing device 1000 (S1200). The media reproducing device 1000 may confirm that the media processing device 900 is connected according to the fact that the media processing device 900 provides the high-level voltage to the +5 power line of the wired interface.

By applying high-level voltage to a hot plug detect (HPD) line which has remained at low-level voltage (S1210), the media reproducing device 1000 may notify to the media processing device 900 that the media reproducing device 1000 is connected to the media processing device 900 and it is completely ready to read EDID.

After recognizing that the HPD line transitions to the high level, the media processing device 900 may request the media reproducing device 1000 to provide EDID information through a display data channel (DDC) (S1220).

In response to receiving the request for the EDID information from the media processing device 900, the media reproducing device 1000 may transmit the EDID information to the media processing device 900 (S1230).

If the EDID information is updated after the media reproducing device 1000 transmits the EDID information to the media processing device 900, the updated EDID information may be transmitted from the media reproducing device 1000 to the media processing device 900 through additional data transmission/reception between the media processing device 900 and the media reproducing device 1000. In the updating of the EDID information, for example, when the EDID information includes the Control option flag field of Table 11, it may be determined that the EDID information is updated when at least one Control option flag field is changed among reproducing device-specific VR media data, user-specific VR media data, reproducing device-specific AR media data, user-specific AR media data, and reproducing device-specific AR audio data. Whether there is a change in the Control option flag field may be determined by a user's request or a functional determination of the media reproducing device 1000.

If the EDID information is updated, the media reproducing device 1000 may provide low-level voltage to the HPD line (S1250). In this case, the media reproducing device 1000 may provide the low-level voltage to the HPD line for at least 100 ms.

If the EDID can be read in the media reproducing device 1000, the media reproducing device 1000 may provide high-level voltage to the HPD line (S1260). If the media processing device 900 detects that the media reproducing device 1000 has provided the high-level voltage to the HPD line, the media processing device 900 may request the media reproducing device 1000 to provide the EDID information through DDC (S1270). Upon receiving the request of the EDID information from the media processing device 900, the media reproducing device 1000 may transmit updated EDID information to the media processing device 900 through DDC (S1280).

FIG. 13 is a flowchart illustrating a process in which a media processing device processes media data according to an embodiment.

Each step disclosed in FIG. 13 may be performed by the media processing device 900 of FIG. 9. Specifically, for example, step 1300 of FIG. 13 may be performed by the receiver 910 of the media processing device 900, step 1310 may be performed by the metadata processor 920 and media bitstream processor 930 of the media processing device 900, step 1320 may be performed by the metadata processor 920 of the media processing device 900, and step 1330 may be performed by the transmitter 940 of the media processing device 900. Therefore, in the description of each step of FIG. 13, redundant details described above with reference to FIG. 9 will be omitted or simply described.

In the present specification, terms or sentences are used to define specific information or concept. For example, in the present specification, information on post processing control of a 3D media signal is defined as a “Control option flag”. However, since the “Control option flag” may be replaced with various terms such as a Control option flag, a Control flag, Control option information, or the like, the term or sentence used in the present specification to define specific information or concept should not be interpreted throughout the specification as being limited to its name, but should be interpreted by paying attention to various operations, functions, and effects based on the meaning of the term.

The media processing device 900 according to an embodiment may receive information on reproduction environment of the media reproducing device 1000 from the media reproducing device 1000 (S1300).

In an embodiment, the information on reproduction environment of the media reproducing device 1000 may include EDID, and optionally, the information on reproduction environment may directly imply the EDID. The EDID may include a CTA data block for representing at least one of status information and reproduction capability information of the media reproducing device 1000, and examples of the CTS data block are as shown in Table 1 below.

TABLE 1

| Codes | Type of Data Block |
|---|---|
| 0 | Reserved |
| 1 | Audio Data Block (includes one or more Short Audio |
| | Descriptors) |
| 2 | Video Data Block (includes one or more Short Video |
| | Descriptors) |
| 3 | Vendor-Specific Data Block |
| 4 | Speaker Allocation Data Block |
| 5 | VESA Display Transer Characteristic Data Block [99] |
| 6 | Reserved |
| 7 | Use Extended Tag |

The CTA data block includes tag codes from 0 to 7, and each tag code may be expressed by a binary code. The tag codes of the CTS data block are used to classify information included in the CTA data block according to a type. In particular, if the tag code of the CTA data block is signaled with 7(111)₂, extended tag codes may be used. Examples of the extended tag codes are as shown in Table 2 below.

TABLE 2

| Extended | |
|---|---|
| Tag Codes | Type of Data Block |
| 0 | Video Capability Data Block |
| 1 | Vendor-Specific Video Data Block |
| 2 | VESA Display Device Data Block [100] |
| 3 | VESA Video Timing Block Extension |
| 4 | Reserved for HDMI Video Data Block |
| 5 | Colorimetry Data Block |
| 6 | HDR Static Metadata Data Block |
| 7 | HDR Dynamic Metadata Data Block |
| 8 . . . 12 | Reserved for video-related blocks |
| 13 | Video Format Preference Data Block |
| 14 | YC_{B}C_{R} 4:2:0 Video Date Block |
| 15 | YC_{B}C_{R} 4:2:0 Capability Map Data Block |
| 16 | Reserved for CTA Miscellaneous Audio Fields |
| 17 | Vendor-Specific Audio Data Block |
| 18 | Reserved for HDMI Audio Data Block |
| 19 | Room Configuration Data Block |
| 20 | Speaker Location Data Block |
| 21 . . . 31 | Reserved for audio-related blocks |
| 32 | InfoFrame Data Block (includes one or more |
| | Short InfoFrame Descriptors) |
| 33 . . . 255 | Reserved |

The total number of the extended tag codes may be 256, i.e., extended tag codes 0 to 255, and each of the extended tag codes may be expressed by a hexadecimal code. Each of the extended tag codes is used to classify extended data blocks included in the CTS data block according to a type. Referring to Table 2, it can be seen that a reserved for video-related blocks field is present in the extended tag codes 8 to 12 of the EDID, and the field may include information on reproduction environment related to video of the media reproducing device 1000 for a VR or AR service.

The information on reproduction environment according to an embodiment may include at least one of VR reproduction environment information and AR reproduction environment information. A part of the VR reproduction environment information and AR reproduction environment information may be included in the reserved for video-related blocks field corresponding to the extended tag codes 8 to 12 of the EDID.

In an embodiment, the VR reproduction environment information may include at least one of reproducing device-specific VR media data and user-specific VR media data, and the AR reproduction environment information may include at least one of reproducing device-specific AR media data and user-specific AR media data. Herein, the “reproducing device-specific” may imply a feature unique to the media reproducing device 1000, and the “user-specific” may imply each feature of each user who uses the media reproducing device 1000. In the embodiment, the extended tag codes 8 to 12 of the EDID may be illustrated as shown Table 3 below.

TABLE 3

| Extended | |
|---|---|
| Tag codes | Type of data block |
| 8 | VR static metadata block |
| 9 | VR dynamic metadata block |
| 10 | AR static metadata block |
| 11 | AR dynamic metadata block |
| 12 | Reserved for future use |

In Table 3, the VR static metadata block field of the extended tag code 8 may indicate reproducing device-specific VR media data, the VR dynamic metadata block field of the extended tag code 9 may indicate user-specific VR media data, the AR static metadata block field of the extended tag code 10 may indicate reproducing device-specific AR media data, and the AR dynamic metadata block field of the extended tag code 11 may indicate user-specific AR media data.

Examples of the VR static metadata block of the extended tag code 8 of Table 3 may be as shown in Table 4 below.

TABLE 4

| | bits | | | | | | | |
|---|---|---|---|---|---|---|---|---|
| Byte# | 7 | 6 | 5 | 4 | 3 | 2 | 1 | 0 |

| 1 | Tag code (0x07) | | | Length of following data block = n bytes | |
|---|---|---|---|---|---|
| 2 | Extended tag code (0x08) | | | | |
| 3 | R0 | 2D/3D | Gaze | Number of displays | Device |
| | | flag | tracking | | classification |

| 4 | Display id | |
|---|---|---|
| 5 | Display min luminance | |
| 6 | Display max luminance | Display min luminance |
| 7 | Display max luminance | |
| 8 | Video file format | Image file format |
| 9 | Audio file format | 3D format |

| | |
|---|---|
| 10 | Device computing power |

In Table 4, upper 3 bits of the byte #1 may imply a tag code of the CTA data block, lower 5 bits may imply a length of the CTA data block, and the byte #2 may imply an extended tag code of an extended data block. Since Table 4 shows the VR static metadata block, the upper 3 bits of the byte #1 indicate a tag code index 7, and the byte #2 indicates an extended tag code index 8(0x08).

In Table 4 above and Tables to be described below, R # may imply a reserved field for future use.

The Device classification field included in the bits 0 and 1 of the byte #3 of the VR static metadata block may include information on a type of the media reproducing device 1000. The information on the type of the media reproducing device 1000 may include, for example, information on whether the media reproducing device 1000 is an HMD for a VR service, information on whether the media reproducing device 1000 is a fixed device (e.g., TV) capable of receiving the VR service, or the like. The media processing device 900 may select suitable content of media data to be processed, based on the information on the type of the media reproducing device 1000.

The Number of displays field included in the bits 2 to 4 of the byte #3 of the VR static metadata block may include information on the number of displays of the media reproducing device 1000. For example, the number of displays of the media reproducing device 1000 may be 2 for both eyes in case of an HMD, and may be 1 in case of a TV among fixed devices. The media processing device 900 may process media data by considering the number of displays of the media reproducing device 1000, and may transmit the processed media data to the media reproducing device 1000.

The Gaze tracking field included in the bit 5 of the byte #3 of the VR static metadata block may include information on whether the media reproducing device 1000 can provide gaze tracking. The gaze tracking may be a process of tracking a movement of a user's gaze. An area located within a pre-set range from a portion gazed by the user may be displayed clearly, and the remaining areas may be displayed to be blurred. The media processing device 900 may process information on subtitles, graphics, or the like to be displayed in an area located within the pre-set range from the portion gazed by the user, based on the information on whether the media reproducing device 1000 can provide the gaze tracking.

The 2D/3D flag field included in the bit 6 of the byte #3 of the VR static metadata block may include information on a dimension supported by the media reproducing device 1000. The information on the dimension supported by the media reproducing device 1000 may indicate, for example, whether the media reproducing device 1000 can support 2D or can support 3D.

The Display id field included in the byte #4 of the VR static metadata block may include information on a display identification of the media reproducing device 1000. For example, if the media reproducing device 1000 includes a left display and a right display, and if the left display and the right display use separate interfaces, the information on the display identification of the media reproducing device 1000 may identify the left display as an index 0 and the right display as an index 1.

The Display min luminance field included in the bits 0 to 3 of the bytes #5 and 6 of the VR static metadata block may include information on a minimum luminance value that can be provided by the media reproducing device 1000. The media processing device 900 may adjust luminance of media content on the basis of the information on the minimum luminance value that can be provided by the media reproducing device 1000, and may transmit it to the media reproducing device 1000.

The Display max luminance field included in the bits 4 to 7 of the byte #6 of the VR static metadata block may include information on a maximum luminance value that can be provided by the media reproducing device 1000. The media processing device 900 may adjust luminance of media content on the basis of the information on the maximum luminance value that can be provided by the media reproducing device 1000, and may transmit it to the media reproducing device 1000.

The Image file format field included in the bits 0 to 3 of the byte #8 of the VR static metadata block, the Video file format field included in the bits 4 to 7 of the byte #8, and the Audio file format field included in the bits 4 to 7 of the byte #9 may include information on a file format that can be supported by the media reproducing device 1000. The Image file format field, the Video file format field, and the Audio file format field may use at least one flag to indicate the file format that can be supported by the media reproducing device 1000.

In an embodiment, four bits assigned to the image file format field may include a JPEG flag, a PNG flag, a bmp flag, or the like by 1 bit each. In addition, four bits assigned to the video file format field may include an mp4 flag, an mpeg-2 flag, or the like by 1 bit each. In addition, four bits assigned to the audio file format field may include a way flag, an mp3 flag, or the like by 1 bit each. In this case, a format supported in the media reproducing device 100 may be indicated as 1, and a format not supported may be indicated as 0.

Although it is illustrated in Table 4 that each of the Image file format field, Video file format field, and Audio file format field includes 4 bits, this is for exemplary purposes only. The number of bits included in each of the Image file format field, Video file format field, and Audio file format field may vary depending on the number of formats included in each field.

The 3D format field included in the bits 0 to 3 of the byte #9 of the VR static metadata block may include information on a 3D file format that can be supported by the media reproducing device 1000. The 3D file format that can be supported by the media reproducing device 1000 may imply, for example, that left/right are both included in one frame such as side-by-side, top-and-bottom, and may imply that it is configured of left-right frames independently. The media processing device 900 may process media data according to the format that can be supported by the media reproducing device 1000 and may transmit it to the media reproducing device 1000.

The Device computing power field included in the byte #10 of the VR static metadata block may include information on computing power of the media reproducing device 1000. Examples of the computing power of the media reproducing device 100 include a CPU, a RAM, or the like. The media processing device 900 may provide the most suitable media content to the media reproducing device 1000 by considering the computing power of the media reproducing device 1000. For example, if the computing power of the media reproducing device 1000 cannot accommodate the specification of media data processed typically in the media processing device 900, the media processing device 900 may downgrade the specification of the media data processed typically and thereafter may transmit it to the media reproducing device 1000.

Returning to Table 3, an example of the VR dynamic metadata block of the extended tag code 9 of Table 3 may be as shown in Table 5 below.

TABLE 5

| | bits | | | | | | | |
|---|---|---|---|---|---|---|---|---|
| Byte # | 7 | 6 | 5 | 4 | 3 | 2 | 1 | 0 |

| 1 | Tag code (0x07) | | Length of following data |
|---|---|---|---|
| | | | block = n bytes |
| 2 | Extended tag code (0x09) | | |
| 3 | Dominant eye | Color blindness | User's age |

| 4 | User's left eyesight | | |
|---|---|---|---|
| 5 | User's right eyesight | | |
| 6 | Viewport-dependent | Preferred | User's preferred |
| | processing setting | frame | genre |
| | | rate flag | |

| | | |
|---|---|---|
| 7 | User's preferred | User's preferred |
| | color temperature | display mode |

| | |
|---|---|
| 8 | Azimuth center offset |
| 9 | Elevation center offset |
| 10 | Tilt center offset |
| 11 | Horizontal range offset |
| 12 | Vertical range offset |

In Table 5, upper 3 bits of the byte #1 may imply a tag code of the CTA data block, lower 5 bits may imply a length of the CTA data block, and the byte #2 may imply an extended tag code of an extended data block. Since Table 5 shows the VR dynamic metadata block, the upper 3 bits of the byte #1 indicate a tag code index 7, and the byte #2 indicates an extended tag code index 9(0x09).

The User's age field included in the bits 0 to 3 of the byte #3 of the VR dynamic metadata block may include user's age information. If a user inputs an age in the media reproducing device 1000, user's age information may be transmitted to the media processing device 900 by being included in the User's age field. The media processing device 900 may obtain an optimal value for color contrast, color brightness, color saturation, color hue, or the like suitable for each age group, based on the user's age information, and may adjust color contrast, color brightness, color saturation, color hue, or the like of corresponding media content, based on the obtained optimal value. In addition, the media processing device 900 may change recommended content or the like based on genre, rating, or the like of corresponding media content based on the user's age information.

The Color blindness field included in the bits 4 and 5 of the byte #3 of the VR dynamic metadata block may include color blindness information. For example, the color blindness information may use an index 0 to indicate that the user of the media reproducing device 1000 is not color blind, may use an index 1 to indicate that the user is red-green blind, may use an index 2 to indicate that the user is yellow-blue blind, and may use an index 3 to indicate that the user is color blind for all colors. The media processing device 900 may adjust color of media content according to a user's blindness type, and may transmit it to the media reproducing device 1000.

The Dominant eye field included in the bits 6 and 7 of the byte #3 of the VR dynamic metadata block may include information on a user's dominant eye. The user's dominant eye, i.e., superior eye, may be input to the media reproducing device 1000 by the user, or may be sensed by the media reproducing device 1000. In an embodiment, information on the user's dominant eye may use an index 0 to indicate that the user is a right-eyed (i.e., the user relatively more frequently uses visual information obtained through a right eye), may use an index 1 to indicate that the user is left-eyed (i.e., the user relatively more frequently uses visual information obtained through a left eye), and may use an index 2 to indicate that the user is left and right-eyed (i.e., the user evenly uses visual information obtained through both eyes). The media processing device 900 may find a position of an image of another view according to an image of a dominant eye on the basis of information on the user's dominant eye to adjust the position so as to be rendered at a center set by the user, and may determine a position for arranging important information such as subtitles, graphics, or the like.

The User's left eyesight field included in the byte #4 of the VR dynamic metadata block and the User's right eyesight field included in the byte #5 may include information on a user's eyesight. The information on the user's eyesight may be a user's eyesight value set by the user in the media reproducing device 1000. The media processing device 900 may obtain color contrast, color brightness, color saturation, color hue, or the like suitable for a corresponding eyesight, based on the information on the user's eyesight, and may adjust the color contrast, color brightness, color saturation, color hue, or the like of media content, based on the obtained information, and may transmit it to the media reproducing device 1000. In addition, if an eyesight difference between a left eye and a right eye is greater than or equal to a specific value, media content may be subjected to post-processing to correct the eyesight.

The User's preferred genre field included in the bits 0 to 3 of the byte #6 of the VR dynamic metadata block may include user's preference information. The media processing device 900 may determine a recommended content list on the basis of user's preference, and thereafter may transmit it to the media reproducing device 1000.

Meanwhile, although it is described in an example according to Table 5 that color contrast, color brightness, color saturation, color hue, or the like is adjusted through the User's age, dominant eye, User's left/right eyesight, User's preferred genre field, or the like, an embodiment of the present disclosure is not limited to the example. For example, the media reproducing device 1000 may directly perform signaling on an adjustment value such as color contrast, color brightness, color saturation, color hue, or the like, or may perform signaling by considering image conversion according to various filters to be applied or image conversion in a frequency domain (sharpness can be improved when emphasizing a high-frequency signal or a signal of a frequency domain in which a person reacts sensitively after converting an image signal into a frequency signal).

The preferred frame rate flag field included in the bit 4 of the byte #6 of the VR dynamic metadata block may include information on whether the user requests for conversion with a preferred frame rate. The referred frame rate may imply, for example, a maximum frame rate that can be supported by the media reproducing device 1000 or a frame rate set by the user. However, the meaning of the preferred frame rate is not limited to the above description.

The viewport-dependent processing setting field of the byte #6 of the VR dynamic metadata block may include information on whether to consider a user's viewport. For example, the information on whether to consider the user's viewport may use an index 0 to indicate that that an image of a fixed viewport is decoded in the media processing device 900 and is transmitted to the media reproducing device 100 to render it without considering the user's viewport, may use an index 1 to indicate that an image of the user's viewport is decoded in the media processing device 900 and is transmitted to the media reproducing device 100 to render it, and may use an index 2 to indicate that an image of a recommended viewport is decoded in the media processing device 900 and is transmitted to the media reproducing device 100 to render it. Meanwhile, position information related to the user's viewport may be transmitted from the media reproducing device 1000 to the media processing device 900 through a USB.

The User's preferred display mode field included in the bits 0 to 3 of the byte #7 of the VR dynamic metadata block may include information on a display mode preferred by the user. The display mode preferred by the user may include, for example, a theater mode, a game mode, a night view mode, an sRGB mode, a reading mode, a darkroom mode, a clear mode, a soft mode, or the like. The media processing device 900 may process media data on the basis of the information on the display mode preferred by the user and transmit it to the media reproducing device 1000. The media reproducing device 1000 may adjust color contrast, color brightness, or the like on the basis of the received media data and may implement a color suitable for the media reproducing device 1000 and a situation of the media data.

The User's preferred color temperature field included in the bits 4 to 7 of the byte #7 of the VR dynamic metadata block may include information on color temperature preferred by the user. The information on color temperature preferred by the user may include, for example, information on whether the user has to change media content to have the color temperature desired by the user and information on a color temperature setting value desired by the user.

A blue light filter may be applied as an example of changing color temperature. The information on the color temperature preferred by the user may include information on a level of applying the blue light filter, information on whether color impression of an image to which the blue light filter is applied will be corrected similarly to an image before applying the blue light filter, or the like.

The Azimuth center offset field included in the byte #8 of the VR dynamic metadata block, the Elevation center offset field included in the byte #9, and the Tilt center offset field included in the byte #10 may indicate information on whether to adjust a position at which VR media is displayed. Since a display position of an image, calculated by the media reproducing device 1000, may be different from a display position of an image desired by the user, an offset value for correcting the display position of the image may be set. The media processing device 900 may adjust the position of the image on the basis of the received Azimuth center offset information, Elevation center offset information, and Tilt center offset information.

The Horizontal range offset field included in the byte #10 of the VR dynamic metadata block and the Vertical range offset field included in the byte #11 may include information on adjustment of a range of VR media. For example, if the user intends to watch an image of media in a range less than a range value of the media reproducing device 100, the user may input a Horizontal range offset value and a Vertical range offset value and thereafter perform signaling to the media processing device 900 through the Horizontal range offset field and the Vertical range offset field, so that the media processing device 900 adjusts the range of media.

Returning to Table 3, an example of the AR static metadata block field of the extended tag code 10 of Table 3 is as shown in Table 6 below.

TABLE 6

| | bits | | | | | | | |
|---|---|---|---|---|---|---|---|---|
| Byte# | 7 | 6 | 5 | 4 | 3 | 2 | 1 | 0 |

| 1 | Tag code (0x07) | | | Length of following data | |
|---|---|---|---|---|---|
| | | | | block = n bytes | |
| 2 | Extended tag code (0x0A) | | | | |
| 3 | R0 | 2D/3D | Gaze | Number | Device |
| | | Flag | tracking | of | classification |
| | | | | displays | |

| 4 | Display id | |
|---|---|---|
| 5 | Display min luminance | |
| 6 | Display max luminance | Display min luminance |
| 7 | Display max luminance | |
| 8 | Video file format | Image file format |
| 9 | Audio file format | 3D format |

| 10 | Device computing power | | | |
|---|---|---|---|---|
| 11 | R1 | R0 | STC | STD |

| 12 | Display horizontal size | |
|---|---|---|
| 13 | Display vertical size | |
| 14 | Virtual display horizontal size | |
| 15 | Virtual display vertical size | |
| 16 | Projected distance | |
| 17 | Included sensors (GPS, compass, gyroscope, | |
| | magnetometer, accelerometer, barometer, | |
| | proximity sensors, touch sensor) | |
| 18 | Camera id | Number of |
| | | cameras |

| | |
|---|---|
| 19 | Camera position x offset |
| 20 | Camera position y offset |
| 21 | Camera position z offset |
| 22 | Basis position for camera position |
| 23-25 | Intrinsic parameters |
| 26-28 | Extrinsic parameters |
| 29-. . . | Sensor #1 capability (min/max) . . . |

In Table 6, upper 3 bits of the byte #1 may imply a tag code of the CTA data block, lower 5 bits may imply a length of the CTA data block, and the byte #2 may imply an extended tag code of an extended data block. Since Table 6 shows the AR static metadata block, the upper 3 bits of the byte #1 indicate a tag code index 7, and the byte #2 indicates an extended tag code index 10(0x0A).

Since the bytes #3 to 10 of the AR static metadata block of Table 6 include the same field as the bytes #3 to 10 of the VR static metadata block of Table 4, descriptions on the aforementioned content in Table 4 will be omitted.

The STD field included in the bits 0 and 2 of the byte #11 of the AR static metadata block may include information on a see-through of AR glass of the media reproducing device 1000. A unit of the see-through of AR glass may be represented as percentage, and for example, information on the see-through of AR glass may be signaled in such a manner that an index 0 is used to indicate a see-through of 90%, an index 1 is used to indicate a see-through of 85%, an index 2 is used to indicate a see-through of 80%, and an index 3 is used to indicate a see-through of 75%.

The STC field included in the bits 3 to 5 of the byte #11 of the AR static metadata block may indicate information on color of a display of AR glass. For example, the information on color of the display of AR glass may use an index 0 to indicate black, use an index 1 to indicate green, use an index 2 to indicate red, and use an index 3 to indicate blue.

The media processing device 900 according to an embodiment may adjust color contrast, color brightness, color saturation, color hue, or the like of media content, based on the information on the see-through of AR glass and the information on color of the display of AR glass.

The Display horizontal size field included in the byte #12 of the AR static metadata block and the Display vertical size field included in the byte #13 may include information on a horizontal or vertical direction size of an actual display. A unit of the horizontal or vertical direction size of the actual display may be expressed by millimeter (mm), and optionally, a diagonal size of the actual display may be expressed in unit of inch without distinction of horizontal/vertical. When the diagonal size of the actual display is expressed in unit of inch, a value obtained by multiplying the diagonal size (inch) of the actual display by 100 may be signaled. In addition, at least one of the Display horizontal size field and the Display vertical size field may additionally include spatial resolution information that can be provided in the display.

The Virtual display horizontal size field included in the byte #14 of the AR static metadata block, the Virtual display vertical size field included in the byte #15, and the Projected distance field included in the byte #16 may include information on a horizontal or vertical directional size of a virtual display according to a projected distance. A unit of the projected distance and the horizontal or vertical directional size of the virtual display according to the projected distance may be expressed by meter (m), and optionally, a diagonal size of the virtual display may be expressed in unit of inch without distinction of horizontal/vertical. When the diagonal size of the virtual display is expressed in unit of inch, a value obtained by multiplying the diagonal size (inch) of the virtual display by 100 may be signaled.

The Included sensors field included in the byte #17 of the AR static metadata block may include information on a sensor included in AR glass. The Included sensors field may include, for example, a flag indicating whether each sensor is included, for example, in the byte #17, by 1 bit each. The sensor that can be included in the AR glass may include, for example, a GPS, a compass, a gyroscope, a magnetometer, an accelerometer, a barometer, a proximity sensor, a touch sensor, a gaze tracking sensor, or the like, but the embodiment is not limited thereto.

Information on the sensor included in the AR glass according to an embodiment may additionally include information on capability that can be processed by the sensor, as well as a type of the sensor included in the AR glass. The information on the capability that can be processed by the sensor may be expressed by extending EDID or InfoFrame. If the EDID is extended, the media reproducing device 1000 may inform the media processing device 900 of a maximum value (min) or maximum value (max) of the capability that can be processed by the sensor included in the AR glass. If the InfoFrame is extended, the media processing device 900 may inform the media reproducing device 1000 of a converted sensor data value (e.g., min or max).

The Number of cameras field included in the bits 0 and 1 of the byte #18 of the AR static metadata block may include information on the number of at least one camera included in the AR glass.

The Camera id field included in the bits 2 to 7 of the byte #18 of the AR static metadata block may include information on an identification (ID) of at least one camera included in the AR glass. More specifically, if the at least one camera included in the AR glass uses each interface, the media processing device 900 may identify the at least one camera included in the AR glass and an interface corresponding thereto on the basis of information on the ID of the at least one camera included in the AR glass.

However, the embodiment is not limited thereto, and for example, the at least one camera included in the AR glass may use the same interface. In this case, the at least one camera included in the AR glass may share camera-related information included in the bytes #19 to 21 of the AR static metadata block.

The Camera position x offset field, Camera position y offset field, Camera position z offset field, and Basis position for camera position field included in the bytes #19 to 22 of the AR static metadata block may include information on a position of the at least one camera included in the AR glass. The Basis position for camera position field may include information on a position used as a reference point for deriving the position of the at least one camera included in the AR glass. The Camera position x offset field and the Camera position y offset field may include information on how far the camera is separated in an x-axis and y-axis direction from a position used as a reference point. In addition, since there may be a depth difference between the position used as the reference point and the position of the camera, the Camera position z offset field may perform signaling on the depth difference between the position used as the reference point and the position of the camera. The position of at least one camera included in the AR glass may be derived based on information included in the Camera position x offset field, Camera position y offset field, Camera position z offset field, and Basis position for camera position field.

The Intrinsic parameters field included in the bytes #23 to 25 of the AR static metadata block and the Extrinsic parameters field included in the bytes #26 to 28 of the AR static metadata block may include information on each of parameters of the at least one camera included in the AR glass.

The Intrinsic parameters field may include information on camera intrinsic parameter. The information on the camera intrinsic parameter may be used for camera calibration. The camera intrinsic parameter may include, for example, focal length (a, b), a principal point (u, v), a skew coefficient (skew_c=tan α), etc. The camera intrinsic parameter may be expressed by a matrix A of Equation 1 below.

$$A = [ \begin{matrix}a & skew\_c & u\end{matrix} ] \\ [ \begin{matrix}0 & b & v\end{matrix} ] \\ [ \begin{matrix}0 & 0 & 1\end{matrix} ] \qquad [ Equation 1 ]$$

The Extrinsic parameters field may include information on a camera extrinsic parameter. The camera extrinsic parameter may be used to recognize a position of a camera. In addition, the camera extrinsic parameter may be used to explain a conversion relation between a camera coordinate system for camera calibration and a world coordinate system, and more specifically, may be used for rotation and translation conversion between the camera coordinate system and the world coordinate system. The camera extrinsic parameter may be expressed by a matrix P of Equation 2 below.

P=A[R t] [Equation 2]

In Equation 2, R is represented by a 3×3 matrix as a level of rotating about an origin of a world coordinate system, and may be replaced with yaw, pitch, and roll values of a camera. t may be represented by a 3×1 vector as a level of moving from the origin of the world coordinate system. Therefore, a camera extrinsic parameter may represent the level by which the camera moves from the origin of the world coordinate system as a 3×4 matrix.

Returning to Table 3, an example of the AR dynamic metadata block field of the extended tag code 11 of Table 3 is as shown in Table 7 below.

TABLE 7

| | bits | | | | | | | |
|---|---|---|---|---|---|---|---|---|
| Byte # | 7 | 6 | 5 | 4 | 3 | 2 | 1 | 0 |

| 1 | Tag code (0x07) | | Length of following data |
|---|---|---|---|
| | | | block = n bytes |
| 2 | Extended tag code (0x0B) | | |
| 3 | Dominant eye | Color blindness | User's age |

| 4 | User's left eyesight | | |
|---|---|---|---|
| 5 | User's right eyesight | | |
| 6 | reserved for future use | PFRF | User's preferred |
| | | | genre |

| | | |
|---|---|---|
| 7 | User's preferred | User's preferred |
| | color temperature | display mode |

| | |
|---|---|
| 8 | Azimuth center offset |
| 9 | Elevation center offset |
| 10 | Tilt center offset |
| 11 | Horizontal range offset |
| 12 | Vertical range offset |

In Table 7, upper 3 bits of the byte #1 may imply a tag code of the CTA data block, lower 5 bits may imply a length of the CTA data block, and the byte #2 may imply an extended tag code of an extended data block. Since Table 7 shows the AR dynamic metadata block, the upper 3 bits of the byte #1 indicate a tag code index 7, and the byte #2 indicates an extended tag code index 11(0x0B).

Since fields disclosed in the AR dynamic metadata block of Table 7 have been described above in Table 5, descriptions of each field of Table 7 will be omitted.

Meanwhile, although the extended tag codes 8 to 12 of EDID has been described in Table 3 by classifying into the reproducing device-specific VR media data, the user-specific VR media data, the reproducing device-specific AR media data, and the user-specific AR media data, an embodiment is not limited thereto. For example, the extended tag codes 8 to 12 of EDID may be configured as shown in Table 8 below.

TABLE 8

| Extended | |
|---|---|
| Tag codes | Type of data block |
| 8 | VR/AR display metadata |
| | block |
| 9 | VR/AR device metadata |
| | block |
| 10 | VR/AR audio metadata block |
| 11 | VR specific metadata |
| 12 | AR specific metadata |

The VR/AR display metadata block field of the extended tag code 8 of Table 8 may include information related to a VR/AR display. The VR/AR device metadata block field of the extended tag code 9 may include information related to the VR/AR media reproducing device 1000. The VR/AR audio metadata block field of the extended tag code 10 may include information related to VR/AR audio. In addition, the VR specific metadata field of the extended tag code 11 of Table 8 may additionally include information on only a VR-specific characteristic. The AR specific metadata field of the extended tag code 12 may additionally include information on only an AR-specific characteristic. Of course, Table 8 is only an example of configuring the extended tag codes 8 to 12, and the extended tag codes 8 to 12 of EDID can be configured in various manners in addition thereto, which will be easily understood by those who ordinarily skilled in the art.

Returning to Table 2, it can be seen that the Reserved for audio-related blocks field is present in the extended tag codes 21 to 31 of EDID. The field may include information on reproduction environment related to audio of the media reproducing device 1000 for a VR or AR service.

The information on reproduction environment according to an embodiment may include AR reproduction environment information, and a part of the AR reproduction environment information may be included in the Reserved for audio-related blocks field corresponding to the extended tag codes 21 to 31 of EDID. The Reserved for audio-related blocks field may include, for example, reproducing device-specific AR audio data in the extended tag code 21 as shown in Table 9.

TABLE 9

| Extended | |
|---|---|
| Tag codes | Type of data block |
| 21 | AR static metadata block for |
| | Audio |

In Table 9, the AR static metadata block for Audio field of the extended tag code 21 indicates the reproducing device-specific AR audio data. Although it is disclosed in Table 9 that the AR static metadata block for Audio field is included in the extended tag code 21, the field can be included in any extended tag code among the extended tag codes 21 to 31, which will be easily understood by those ordinarily skilled in the art.

An example of the AR static metadata block for Audio of the extended tag code 21 of Table 9 is as shown in Table 10 below.

TABLE 10

| | bits | | | | | | | |
|---|---|---|---|---|---|---|---|---|
| Byte # | 7 | 6 | 5 | 4 | 3 | 2 | 1 | 0 |

| | | |
|---|---|---|
| 1 | Tag code (0x07) | Length of following data block = n bytes |

| 2 | Extended tag code (0x15) | |
|---|---|---|
| 3 | Number of speakers | SPKF |
| 4 | Speaker position | |
| 5 | Speaker position x offset | |
| 6 | Speaker position y offset | |
| 7 | Speaker position z offset | |
| 8 | MIC position | MIC flag |

| | |
|---|---|
| 9 | MIC position x offset |
| 10 | MIC position y offset |
| 11 | MIC position z offset |

In Table 10, upper 3 bits of the byte #1 may imply a tag code of the CTA data block, lower 5 bits may imply a length of the CTA data block, and the byte #2 may imply an extended tag code of an extended data block. Since Table 10 shows the AR static metadata block for Audio, the upper 3 bits of the byte #1 indicate a tag code index 7, and the byte #2 indicates an extended tag code index 21(0x15).

The SPKF (Included speaker flag) field included in the bit 0 of the byte #3 of the AR static metadata block for Audio may include information on whether at least one speaker is included in the AR glass.

The Number of speakers field included in the bits 1 to 7 of the byte #3 of the AR static metadata block for Audio may include information on the number of one or more speakers included in the AR glass. Although signaling of the Number of speakers field is based on a case where one interface is present for each speakers, an embodiment is not limited thereto. For example, at least one speaker included in the AR glass may share one interface. In this example, signaling may be extended so that information on each position of at least one speaker included in the AR glass is transferred to all of at least one speaker included in the AR glass.

The Speaker position field included in the byte #4 of the AR static metadata block for Audio may include position information of a reference point for deriving each position of at least one speaker included in the AR glass. For example, the position information of the reference point may include information on whether the reference point is a center point of a left display, a center point of a right display, or a center point of a center display. In addition, for example, the position information of the reference point may perform signaling on a specific position value of the reference point by using a coordinate.

The Speaker position x offset field included in the byte #5 of the AR static metadata block for Audio, the Speaker position y offset field included in the byte #6, and the Speaker position z offset field included in the byte #7 may indicate information on each position of at least one speaker included in the AR glass. The Speaker position x offset field and the Speaker position y offset field may include information on how far the speaker is separated in an x-axis and y-axis direction from a position used as a reference point. In addition, since there may be a depth difference between the position used as the reference point and the position of the speaker, the Speaker position z offset field may perform signaling on the depth difference between the position used as the reference point and the position of the speaker. The position of at least one speaker included in the AR glass may be derived based on information included in the Speaker position x offset field, Speaker position y offset field, and Speaker position z offset field. The position of at least one speaker included in the AR glass may be considered when audio is rendered.

The MIC flag field included in the bit 0 of the byte #8 of AR static metadata block for Audio may include information on whether at least one microphone (MIC) is included in the AR glass.

The MIC position field included in the bits 1 to 7 of the byte #8 of the AR static metadata block for Audio may include position information of a reference point for deriving each position of at least one microphone included in the AR glass. For example, the position information of the reference point may include information on whether the reference point is a center point of a left display, a center point of a right display, or a center point of a center display. In addition, for example, the position information of the reference point may perform signaling on a specific position value of the reference point by using a coordinate.

The MIC position x offset field included in the byte #9 of the AR static metadata block for Audio, the MIC position y offset field included in the byte #10, and the MIC position z offset field included in the byte #11 may indicate information on each position of at least one microphone included in the AR glass. The MIC position x offset field and the MIC position y offset field may include information on how far the microphone is separated in an x-axis and y-axis direction from a position used as a reference point. In addition, since there may be a depth difference between the position used as the reference point and the position of the microphone, the MIC position z offset field may perform signaling on the depth difference between the position used as the reference point and the position of the microphone. The position of at least one microphone included in the AR glass may be derived based on information included in the MIC position x offset field, MIC position y offset field, and MIC position z offset field. The position of at least one microphone included in the AR glass may be signaled by being derived when voice is recorded in the microphone, and thereafter when the speaker reproduces the recorded voice, the speaker may render audio by considering the position of at least one microphone included in the AR glass.

Meanwhile, when the aforementioned offset values are signaled, the most significant 1 bit may be used as a sign bit (e.g., +, −). Further, a method for signaling the position information of the speaker, microphone, or the like is not limited to the above description, and the position information of the speaker, microphone, or the like may be signaled by using a more simplified method. In addition, the information on the microphone may include InfoFrame instead of EDID. Detailed descriptions on the InfoFrame will be described below in S1320.

Meanwhile, although it has been described with reference to Table 1 to Table 10 that the information on reproduction environment of the media reproducing device 1000 includes EDID, or the information on reproduction environment is directly the EDID, an embodiment is not limited thereto.

The information on reproduction environment of the media reproducing device 1000 according to another embodiment may include DisplayID, and optionally, the information on reproduction environment may directly imply DisplayID.

In an embodiment, a data block of DisplayID may be defined as shown in Table 11 below.

TABLE 11

| Offset | Value | | | | | | | | Description/Format |
|---|---|---|---|---|---|---|---|---|---|
| 0x00 | 0x14 | | | | | | | | VR static Data Block |
| 0x01 | 7 | 6 | 5 | 4 | 3 | 2 | 1 | 0 | BLOCK Revision and |
| | | | | | | | | | Other Data |
| | — | — | — | — | — | 0 | 0 | 0 | REVISION ‘0’ |
| | 0 | 0 | 0 | 0 | 0 | — | — | — | RESERVED (BLOCK |
| | | | | | | | | | SPECIFIC) |

| | | |
|---|---|---|
| 0x02 | | Number Of Payload |
| | | Bytes |
| 0x03 | Descriptor | Control option flag |
| 0x04- | Descriptor | VR static metadata |
| 0x11 | | |
| 0x12- | Descriptor | VR dynamic metadata |
| 0x15 | | |
| 0x16- | Descriptor | AR static metadata |
| 0x41 | | |
| 0x42- | Descriptor | AR dynamic metadata |
| 0x51 | | |
| 0x52- | Descriptor | AR static metadata for |
| 0x60 | | Audio |

The data block of DisplayID disclosed in Table 11 includes the Control option flag field, the VR static metadata field, the VR dynamic metadata field, the AR static metadata field, the AR dynamic metadata field, the AR static metadata for Audio field, or the like.

The VR static metadata field, VR dynamic metadata field, AR static metadata field, AR dynamic metadata field, and AR static metadata for Audio field of Table 11 may respectively correspond to the VR static metadata block field, VR dynamic metadata block field, AR static metadata block field, and AR dynamic metadata block field of Table 3 and the AR static metadata block for Audio field of Table 9. Therefore, redundant descriptions on each field will be omitted.

The Control option flag field of Table 11 may include information on a control of prost processing performed in the media processing device 900. The Control option flag field may be signaled by a user's request, or may be controlled by a function determination of the media reproducing device 1000 (in this case, processing capability of the media reproducing device 1000 shall be superior to processing capability of the media processing device 900).

The Control option flag field may include, for example, information as shown in Table 12 below.

TABLE 12

| Offset | Value | | | | | | | | Description/Format |
|---|---|---|---|---|---|---|---|---|---|
| 0x03 | 7 | 6 | 5 | 4 | 3 | 2 | 1 | 0 | Control Option Flag |
| | 1 | — | — | — | — | — | — | — | Activate VR processing |
| | | | | | | | | | in source device based |
| | | | | | | | | | on VR static metadata |
| | — | 1 | — | — | — | — | — | — | Activate VR processing |
| | | | | | | | | | in source device based |
| | | | | | | | | | on VR dynamic metadata |
| | — | — | 1 | — | — | — | — | — | Activate AR processing |
| | | | | | | | | | in source device based |
| | | | | | | | | | on AR static metadata |
| | — | — | — | 1 | — | — | — | — | Activate AR processing |
| | | | | | | | | | in source device based |
| | | | | | | | | | on AR dynamic metadata |
| | — | — | — | — | 1 | — | — | — | Activate AR processing |
| | | | | | | | | | in source device based |
| | | | | | | | | | on AR Audio static |
| | | | | | | | | | metadata |

| | | | | | | |
|---|---|---|---|---|---|---|
| — | — | — | — | — | reserved | Reserved |

In Table 12, the Activate VR processing in source device based on VR static metadata field may indicate information on whether information on the VR static metadata field will be included in offsets 0x04 to 0x11 of the data block of DisplayID. The Activate VR processing in source device based on VR dynamic metadata field may indicate information on whether information on the VR dynamic metadata field will be included in offsets 0x12 to 0x15 of the data block of DisplayID. The Activate AR processing in source device based on AR static metadata field may indicate information on whether information on the AR static metadata field will be included in offsets 0x16 to 0x41 of the data block of DisplayID. The Activate AR processing in source device based on AR dynamic metadata field may indicate information on whether information on the AR dynamic metadata field will be included in offsets 0x42 to 0x51 of the data block of DisplayID. The Activate AR processing in source device based on AR Audio static metadata field may indicate information on whether information on the AR static metadata for Audio field will be included in offsets 0x52 to 0x60 of the data block of DisplayID. The Reserved field of Table 12 implies a space in which a field can be additionally arranged according to the development of the future VR/AR system.

In another embodiment, Display Parameters Data Block of DisplayID may be configured as shown in Table 13 below.

TABLE 13

| Offset | Value | | | | | | | | Description/Format |
|---|---|---|---|---|---|---|---|---|---|
| 00ₕ | 01ₕ | | | | | | | | DISPLAY |
| | | | | | | | | | PARAMETERS |
| | | | | | | | | | DATA BLOCK TAG |
| 01ₕ | 7 | 6 | 5 | 4 | 3 | 2 | 1 | 0 | BLOCK Revision and |
| | | | | | | | | | Other Data |
| | — | — | — | — | — | 0 | 0 | 0 | REVISION ‘0’ |
| | | | | | | | | | VALUES 0−>7 |
| | 0 | 0 | 0 | 0 | 0 | — | — | — | RESERVED |

| | | |
|---|---|---|
| 02ₕ | 0Cₕ | Number of Payload |
| | | Bytes in BLOCK |
| | | 12 |
| 03ₕ 04ₕ | DESCRIPTOR | Horizontal image size |
| | | Section 4.2.1 |
| 05ₕ 06ₕ | DESCRIPTOR | Vertical image size |
| | | Section 4.2.1 |
| 07ₕ 08ₕ | DESCRIPTOR | Horizontal pixel count |
| | | Section 4.2.1 |
| 09ₕ 0Aₕ | DESCRIPTOR | Vertical pixel count |
| | | Section 4.2.3 |
| 0Bₕ | DESCRIPTOR | Feature Support Flags |
| | | Section 4.2.3 |
| 0Cₕ | DESCRIPTOR | Transfer Characteristic |
| | | Gamma Section 4.2.4 |
| 0Dₕ | DESCRIPTOR | Aspect Ratio |
| | | Section 4.2.5 |
| 0Eₕ | DESCRIPTOR | Color Bit Depth |
| | | Section 4.2.6 |

The Display Parameters Data Block of Table 13 may include the Horizontal image size field including information on a horizontal size of an image, the Vertical image size field including information on a vertical size of the image, the Horizontal pixel count field including information on the number of horizontal pixels of the image, the Vertical pixel count field including information the number of vertical pixels of the image, the Feature Support Flags field including flag information on a function that can be supported in a display, the Transfer Characteristic Gamma field including information on a gamma used in a transfer function, the (display) Aspect Ratio field, and the Color Bit Depth field.

Further, in addition to the field disclosed in Table 13, the display parameters data block field may additionally include the Control option flag field, VR static metadata field, VR dynamic metadata field, AR static metadata field, AR dynamic metadata field, and AR static metadata for Audio field described above in Table 11.

The Display Parameters Data Block of Table 13 may optionally include only information related to a display of the media reproducing device 1000 for receiving a VR or AR service. In this case, the Display Parameters Data Block may include the Control option flag field and display-related fields included in the byte #3 to 16 of Table 6.

In another embodiment, the Display Device Data block defining a characteristic of a panel itself in DisplayID may be configured as shown in Table 14 below.

TABLE 14

| Offset | Value | | | | | | | | Description/Format |
|---|---|---|---|---|---|---|---|---|---|
| 00ₕ | 0Cₕ | | | | | | | | DISPLAY DEVICE |
| | | | | | | | | | DATA BLOCK TAG |
| 01ₕ | 7 | 6 | 5 | 4 | 3 | 2 | 1 | 0 | BLOCK Revision and |
| | | | | | | | | | Other Data |
| | — | — | — | — | — | 0 | 0 | 0 | REVISION ‘0’ |
| | | | | | | | | | VALUES 0−>7 |
| | 0 | 0 | 0 | 0 | 0 | — | — | — | RESERVED |

| | | |
|---|---|---|
| 02ₕ | 0Dₕ | Number of Payload |
| | | Bytes in BLOCK |
| | | 13 |
| 03ₕ | DESCRIPTOR | Display Device |
| | | Technology |
| 04ₕ | DESCRIPTOR | Device operating |
| | | mode |
| 05ₕ−>08ₕ | DESCRIPTOR | Device native pixel |
| | | format |
| 09ₕ−>0Aₕ | DESCRIPTOR | Aspect ratio and |
| | | orientation |
| 0Bₕ | DESCRIPTOR | Sub-pixel layout/ |
| | | configuration/shape |
| 0Cₕ−>0Dₕ | DESCRIPTOR | Horizontal and vertical |
| | | dot/pixel pitch |
| 0Eₕ | DESCRIPTOR | Color bit depth |
| 0Fₕ | DESCRIPTOR | Response time |

The Display Device Data Block of Table 14 may include the Display Device Technology field including information on a type of a display device, the Device operating mode field, the Device native pixel format field including information on an image size that can be represented by the number of pixels, the Aspect ratio and orientation field, the Sub-pixel layout/configuration/shape field, the Horizontal and vertical dot/pixel pitch field, the Color bit depth field, the Response time field, or the like.

Further, in addition to the field disclosed in Table 14, the display device data block field may additionally include the Control option flag field, the VR static metadata field, the VR dynamic metadata field, the AR static metadata field, the AR dynamic metadata field, and the AR static metadata for Audio field, described above in Table 11.

The Display Device Data Block of Table 14 may optionally include only information related to a display of the media reproducing device 1000 for receiving a VR or AR service. In this case, the Display Device Data Block may include the Control option flag field and display-related fields included in the bytes #3 to 16.

In another embodiment, in Display ID, a vendor-specific data block used to transmit information not defined in a current data block may additionally include the Control option flag field, the VR static metadata field, the VR dynamic metadata field, the AR static metadata field, the AR dynamic metadata field, and the AR static metadata for Audio field, described above in Table 11.

In another embodiment, in DisplayID, a production identification data block providing information on a manufacturer of a display device, a serial number of the display device, a product ID, or the like may additionally include the Control option flag field, the VR static metadata field, the VR dynamic metadata field, the AR static metadata field, the AR dynamic metadata field, and the AR static metadata for Audio field, described above in Table 11.

Meanwhile, the information on reproduction environment of the media reproducing device 1000 is not limited to the aforementioned EDID or DisplayID. For example, the information on reproduction environment of the media reproducing device 1000 may include EDID extension, or the information on reproduction environment may be directly EDID extension. An example of the EDID extension is as shown in Table 15 below.

TABLE 15

| | Byte # | Bits 5-7 | Bits 0-4 |
|---|---|---|---|
| Video Data | 1 | Video Tag | length = total number of video bytes |
| Block | | Code | following this byte ( [symbol] ) |
| | 2 | CEA Short Video Descriptor 1 | |
| | 3 | CEA Short Video Descriptor 2 | |
| | . . . | . . . | |
| | 1 + [symbol] | CEA Short Video Descriptor [symbol] | |
| Audio Data | 2 + [symbol] | Audio Tag | length = total number of audio bytes |
| Block | | Code | following this byte ( [symbol] ) |
| | 3 + [symbol] | CEA Short Audio Descriptor 1 | |
| | 4 + [symbol] | | |
| | 5 + [symbol] | | |
| | . . . | | |
| | [symbol] + L₂ | CEA Short Audio Descriptor L [symbol] | |
| | 1 + [symbol] + L₂ | | |
| | 2 + [symbol] + L₂ | | |
| Speaker | 3 + [symbol] + L₂ | Speaker | length = total number of speaker allocation |
| Allocation | | Allocation | bytes following this byte (L [symbol] = 3) |
| Data | | Tag Code | |
| Block | 4 + [symbol] + L₂ | Speaker Allocation Data Block Payload (3 bytes) | |
| | 5 + [symbol] + L₂ | | |
| | 6 + [symbol] + L₂ | | |
| Vendor- | 7 + [symbol] + L₂ | Vendor- | length = total number of Vendor-Specific |
| Specific | | Specific | bytes following this byte (L [symbol] ) |
| Data | | Tag Code | |
| Block | 8 + [symbol] + L₂ | IEEE OUI third two hex digits | |
| | 9 + [symbol] + L₂ | IEEE OUI second two hex digits | |
| | 10 + [symbol] + L₂ | IEEE OUI first two hex digits | |
| | . . . | Vendor-Specific Data Block Payload (L [symbol] 3 bytes) | |
| Video | 8 + L₁ + L₂ + [symbol] | Extended | length = total number of bytes in this block |
| Capability | | Tag Code | following this byte (L [symbol] ) |
| Data | 9 + L₁ + L₂ + [symbol] | Video Capabilities Ext. Tage Code = 00 h | |
| Block | 10 + L₁ + L₂ + [symbol] | Video Capabilities Data Byte 3 (see Section 7.5. [symbol] ) | |
| VR/AR | 11 + L₁ + L₂ + [symbol] + [symbol] | Extended | length = total number of bytes in this block |
| Data | | Tag Code | following this byte (L [symbol] ) |
| Block | 12 + [symbol] + [symbol] + [symbol] + [symbol] | VR static metadata block | |
| | . . . 19 + [symbol] + [symbol] + [symbol] + [symbol] | | |
| | 20 + [symbol] + [symbol] + [symbol] + [symbol] | VR dynamic metadata block | |
| | . . . 24 + [symbol] + [symbol] + [symbol] + [symbol] | | |
| | 25 + [symbol] + [symbol] + [symbol] + [symbol] | AR static metadata block | |
| | . . . 50 + [symbol] + [symbol] + [symbol] + [symbol] | | |
| | 51 + [symbol] + [symbol] + [symbol] + [symbol] | AR dynamic metadata block | |
| | . . . 60 + [symbol] + [symbol] + [symbol] + [symbol] | | |
| | 61 + [symbol] + [symbol] + [symbol] + [symbol] | AR static metadata block for Audio | |
| | . . . 69 + [symbol] + [symbol] + [symbol] + [symbol] | | |

[symbol]

indicates data missing or illegible when filed

As disclosed in Table 15, EDID extension may include a VR/AR data block, and the VR/AR data block may include a VR static metadata block, a VR dynamic metadata block, an AR static metadata block, an AR dynamic metadata block, and an AR static metadata block for Audio. The VR/AR data block including the VR static metadata block, the VR dynamic metadata block, the AR static metadata block, the AR dynamic metadata block, and the AR static metadata block for Audio has been described with reference to Table 3 and Table 9.

Meanwhile, although it is disclosed in Table 15 that the VR/AR data block includes a VR static metadata block, a VR dynamic metadata block, an AR static metadata block, an AR dynamic metadata block, and an AR static metadata block for Audio, this is for exemplary purposes only. For example, as shown in Table 8, the VR/AR data block may include a VR/AR display metadata block, a VR/AR device metadata block, a VR/AR audio metadata block, VR specific metadata, and AR specific metadata.

The media processing device 900 according to an embodiment may generate a media signal by processing a media bitstream on the basis of the information on reproduction environment of the media reproducing device 1000 (S1310).

The media processing device 900 according to an embodiment may extract characteristic information of the generated media signal (S1320).

The characteristic information of the generated media signal may include information regarding which process has been performed and information regarding values converted after processing, in a process in which the media processing device 900 processes media suitable for reproduction in the media reproducing device 1000. In an embodiment, the characteristic information of the generated media signal may include Infoframe. The Infoframe may be Infoframe defined in CTA-861-G, but is not limited thereto.

A list of Infoframe type codes may be as shown in Table 16 below.

TABLE 16

| Info Frame | |
|---|---|
| Type Code | Type of Infoframe |
| 0x00 | Reserved |
| 0x01 | Vendor-Specific (defined in Section 6.1) |
| 0x02 | Auxiliary Video Information (defined in Section |
| | 6.4) |
| 0x03 | Source Product Description (defined in Section 6.5) |
| 0x04 | Audio (defined in Section 6.6 of CTA-861) |
| 0x05 | MPEG Source (defined in Section 6.7 of CTA-861) |
| 0x06 | NTSC VBI (defined in Section 6.8 of CTA-861) |
| 0x07 | Dynamic Range and Mastering (defined in Section |
| | 6.9 of CTA-861) |
| 0x08-0x1F | Reserved for future use |
| 0x20-0xFF | Forbidden |

The Infoframe type code 0x08-0x1F of Table 16 implies a field reserved for future technical development. The Infoframe type code 0x08 according to an embodiment of the present disclosure may indicate a VR display mode field, and the Infoframe type code 0x09 may indicate an AR display mode field, and a 0x0A field may indicate an AR audio rendering mode field.

In an embodiment, the VR display mode field corresponding to the Infoframe type code 0x08 may be configured as shown in Table 17 below.

TABLE 17

| InfoFrame | InfoFrame Type = 0x08 (VR display mode | | | | | | | |
|---|---|---|---|---|---|---|---|---|
| Type Code | InfoFrame) | | | | | | | |
| InfoFrame | Version = 0x01 | | | | | | | |
| Version | | | | | | | | |
| Number | | | | | | | | |
| Length of VR | Length of following data bytes | | | | | | | |
| display | | | | | | | | |
| mode InfoFrame | | | | | | | | |
| Byte # | 7 | 6 | 5 | 4 | 3 | 2 | 1 | 0 |

| | | | | |
|---|---|---|---|---|
| Data Byte 1 | R0 | LRO | 3DCF | contents type |

| | | | | | | | |
|---|---|---|---|---|---|---|---|
| Data Byte 2 | VT | CTF | HCF | SCF | BCF | CCF | PCF |

| | | | |
|---|---|---|---|
| Data Byte 3 | Reserved for future use | CBCF | FFCF |

| Data Byte 4 | X offset | | | | |
|---|---|---|---|---|---|
| Data Byte 5 | Y offset | | | | |
| Data Byte 6 | Contrast offset | | | | |
| Data Byte 7 | Brightness offset | | | | |
| Data Byte 8 | Saturation offset | | | | |
| Data Byte 9 | Hue offset | | | | |
| Data Byte 10 | R1 | R0 | Color 2 | Color 1 | Hue offset |

| | |
|---|---|
| Data Byte 11 | Color offset 1 |
| Data Byte 12 | Color offset 2 |
| Data Byte 13 | File format |
| Data Byte 14-17 | Azimuth center |
| Data Byte 18-21 | Elevation center |
| Data Byte 22-25 | Tilt center |

The contents type field included in the bits 0 to 3 of the byte #1 of the VR display mode InfoFrame may include information on a media data type. Examples of the media data type may include media data for VR HMD media data, media data for fixed device, media data for AR glass, or the like. The contents type field may include, for example, a flag indicating whether it is the media data for VR HMD, a flag indicating whether it is the media data for fixed device, a flag indicating whether it is the media data for AR glass, or the like by assigning each of the flags to one bit.

The 3DCF field included in the bit 4 of the byte #1 of the VR display mode InfoFrame may include information on whether media are displayed as a 3D image. For example, if the media are two separated images, the 3DCF field may indicate whether the media are 3D content or not.

The LRO field included in the bits 5 and 6 of the byte #1 of the VR display mode InfoFrame may include information on whether an image included in media is displayed in left-right order. More specifically, the LRO field may include whether the image included in the media is displayed in left(display)-right(display) order, in right(display)-left(display) order, or irrespective of order. Optionally, if only one image is transferred by performing rendering on a fixed device among images created in the left-right order, the LRO field may indicate whether the image is originally for the left side, right side, or irrespective of the left-right side.

The PCF (position control flag using dominant eye info) field included in the bit 0 of the byte #2 of the VR display mode InfoFrame may include information on a dominant eye. More specifically, since an image position may is changed according to whether a user's dominant eye is a left eye or a right eye or whether the user is left and right eyed, the PCF field may include information on whether the image position is changed based on the user's dominant eye.

The CCF (Contrast Control Flag) field included in the bit 1 of the byte #2 of the VR display mode InfoFrame may include information on whether color contrast is changed. For example, the CCF field may include a flag indicating whether the color contrast is changed.

The BCF (Brightness Control Flag) included in the bit 2 of the byte #2 of the VR display mode InfoFrame may include information on whether color brightness is changed. For example, the BCF field may include a flag indicating whether the color brightness is changed.

The SCF (Saturation Control Flag) field included in the bit 3 of the byte #2 of the VR display mode InfoFrame may include information on whether color saturation is changed. For example, the SCF field may include a flag indicating whether the color saturation is changed.

The HCF (Hue Control Flag) field included in the bit 4 of the byte #2 of the VR display mode InfoFrame may include information on whether color hue is changed. For example, the HCF field may include a flag indicating whether the color hue is changed.

The CTF (Color Temperature Flag) field included in the bit 5 of the byte #2 of the VR display mode InfoFrame may include information on whether it is changed to color temperature preferred by a user. For example, the CTF field may include a flag indicating whether it is changed to the color temperature preferred by the user. If the flag indicating whether it is changed to the color temperature preferred by the user indicates 1, the media processing device 900 may change color impression according to a user setting and transmit it to the media reproducing device 1000. In this case, the InfoFrame may include information on a level of changing the color impression according to the user setting.

The VT (Viewport Type) field included in the bits 6 and 7 of the byte #2 of the VR display mode InfoFrame may include information on whether a user's viewport is considered. More specifically, the VT field may use an index 0 to indicate that a current image is based on the user's viewport, may use an index 1 to indicate that the current image is irrelevant to the user's viewport and is based on a viewport set by the user, and may use an index 2 to indicate that the current image is irrelevant to the user's viewport and is based on a recommended viewport.

The FFCF (File Format Control Flag) field included in the bit 0 of the byte #3 of the VR display mode InfoFrame may include information on whether a media field format is changed. If an Image, video, audio, or 3D format is generated using a field format not supported in the media reproducing device 1000, there is a need to change the file format. The FFCF field may include information on whether the media file format is changed through a flag.

The CBCF (Color Blindness Control Flag) field included in the bits 1 and 2 of the byte #3 of the VR display mode InfoFrame may include information on whether media color is changed based on whether the user is color blind. For example, the CBCF field may use an index 0 to indicate that color of media content is not changed, may use an index 1 to indicate that color of media content is changed by considering that the user is red-green blind, and may use an index 2 to indicate that color of media content is changed by considering that the user is yellow-blue blind.

The x offset field included in the byte #4 of the VR display mode InfoFrame and the y offset field included in the byte #5 may include information on a level by which a position of an image included in media is changed based on information on a user's dominant eye. In other words, the x offset field and the y offset field may include information on a level by which the position of the image included in the media is changed when a flag included in the PCF field indicates 1. In this case, the most significant bit of the x offset field and y offset field may be used as a bit for indicating a sign.

The contrast offset field included in the byte #6 of the VR display mode InfoFrame may include information on a level by which color contrast is changed. The level by which the color contrast is changed may be expressed by %, and the most significant bit of the contrast offset field may be used as a bit for indicating a sign.

The brightness offset field included in the byte #7 of the VR display mode InfoFrame may include information on a level by which the color brightness is changed. The level by which the color brightness is changed may be expressed by %. For example, 0% may indicate black, and 100% may indicate white. The most significant field of the brightness offset field may be used as a bit for indicating a sign.

The saturation offset field included in the byte #8 of the VR display mode InfoFrame may include information on a level by which color saturation is changed. The color saturated may be indicated by 0 to 100%, as color quantity of specific color. The most significant field of the saturation offset field may use a bit for indicating a sign.

The hue offset field included in the bits 0 and 1 of the bytes #9 and 10 of the VR display mode InfoFrame may include information on a level by which color hue is changed. The color hue may be indicated as an angle. For example, 0 degree may indicate red, 60 degrees may indicate yellow, 120 degrees may indicate green, 180 degrees may indicate yellow-blue, 240 degrees may indicate blue, and 300 degrees may indicate red-violet. The most significant bit of the hue offset may be used as a bit for indicating a sign.

The Color 1 field included in the bits 2 and 3 of the byte #10 of the VR display mode InfoFrame, the Color 2 field included in the bits 4 and 5, the Color offset 1 field included in the byte #11, and the Color offset 2 field included in the byte #12 may include information on a level by which color of media is changed based on whether the user is color blind. If the user is red-green blind or yellow-blue blind, the Color 1 field and the Color 2 field may include information on color changed by considering that the user is color blind. In addition, the Color offset 1 field and the Color offset 2 field may include an offset value regarding a way of changing color from Color 1 and Color 2. The most significant bit of the Color offset 1 field and the Color offset 2 field may be used as a bit for indicating a sign.

The File format field included in the byte #13 of the VR display mode InfoFrame may include information on a changed file format of media. In other words, if a flag included in information on whether the file format of media is changed indicates 1, the File format field may include information on the changed file format of media.

The Azimuth center field included in the bytes #14 to 17 of the VR display mode InfoFrame, the Elevation center field included in the types #18 to 21, and the Tilt center field included in the bytes #22 to 25 may include information on a position of a viewport. If the aforementioned VT field indicates an index 1, the information on the position of the viewport may indicate information on a viewport position set by the user. If the aforementioned VT field indicates an index 2, the information on the position of the viewport may indicate information on a position of a recommended viewport. In this case, the position of the recommended viewport may be further finely adjusted. If the aforementioned VT field indicates an index 0, the information on the position of the viewport may indicate information on the position of the viewport of the user. In this case, if the position information of the viewport of the user, calculated by the media reproducing device 1000, is different from a position actually desired by the user, the position information of the viewport of the user may be finely adjusted.

The information on the position of the viewport may include not only Azimuth center, Elevation center, Tilt center but also information on horizontal range and vertical range.

Meanwhile, although signaling of a changed value is primarily disclosed in InfoFrame of Table 17, InfoFrame according to another embodiment may include signaling for an original value. In addition, all values included in the InfoFrame based on Table 17 may be transferred to the media reproducing device 1000 through a USB or the like.

Next, the AR display mode field corresponding to the InfoFrame type code 0x09 may be configured as shown in Table 18 below.

TABLE 18

| InfoFrame Type Code | InfoFrame Type = 0x09 (AR display mode InfoFrame) | | | | | | | |
|---|---|---|---|---|---|---|---|---|
| InfoFrame Version Number | Version | = 0x01 | | | | | | |
| Length of AR InfoFrame | Length of following data bytes | | | | | | | |
| Byte # | 7 | 6 | 5 | 4 | 3 | 2 | 1 | 0 |
| Data Byte 1 | R0 | LRO | | 3DCF | contents type | | | |
| Data Byte 2 | STDF | STCF | CTF | HCF | SCF | BCF | CCF | PCF |
| Data Byte 3 | Reserved for future use | | | | | CBCF | | FFCF |
| Data Byte 4 | X offset | | | | | | | |
| Data Byte 5 | Y offset | | | | | | | |
| Data Byte 6 | Contrast offset | | | | | | | |
| Data Byte 7 | Brightness offset | | | | | | | |
| Data Byte 8 | Saturation offset | | | | | | | |
| Data Byte 9 | Hue offset | | | | | | | |
| Data Byte 10 | R1 | R0 | Color 2 | | Color 1 | | Hue offset | |
| Data Byte 11 | Color offset 1 | | | | | | | |
| Data Byte 12 | Color offset 2 | | | | | | | |
| Data Byte 13 | File format | | | | | | | |
| Data Byte 14 | R4 | R3 | R2 | R1 | R0 | ECF | ICF | CPCF |

| | |
|---|---|
| Data Byte 15 | Recording video rendering position x offset |
| Data Byte 16 | Recording video rendering position y offset |
| Data Byte 17 | Sensor #1 transformed capability (min/max) |
| Data Byte 18 | Sensor #2 transformed capability (min/max) |
| Data Byte 19 | Sensor #3 transformed capability (min/max) |
| Data Byte 20 | Sensor #4 transformed capability (min/max) |
| . . . | . . . |

In Table 18, detailed descriptions on the field redundantly described in Table 17 will be omitted.

The STDF field included in the bit 7 of the byte #2 of the AR display mode InfoFrame may include information on whether an image of media is changed according to a see-through of AR glass of the media reproducing device 1000. The information on whether the image of media is changed according to the see-through of AR glass may be indicated by a flag. If the flag indicates 1, InfoFrame may include information on color contrast, color brightness, color saturation, color hue, or the like of the changed image.

The STCF field included in the bit 6 of the byte #2 of the AR display mode InfoFrame may include information on whether an image of media is changed according to color of a display of AR glass of the media reproducing device 1000. The information on whether the image of media is changed according to the display of AR glass may be indicated by a flag. If the flag indicates 1, InfoFrame may include information on color contrast, color brightness, color saturation, color hue, or the like of the changed image.

Although it is described in Table 18 that information on whether an image of media is changed according to a see-through of AR glass and information on whether the image of media is changed according to color of a display of AR glass are included in additional fields (STDF, STCF), information on whether the image of media is changed according to the see-through of AR glass and information on whether the image of media is changed according to color of the display of AR glass can be included in one field, which can be easily understood by those ordinarily skilled in the art.

The CPCF (Camera Position Control Flag) field included in the bit 0 of the byte #14 of the AR display mode InfoFrame may include information on whether a position of an image obtained through at least one camera included in the AR glass is corrected. Since the position of the camera is different from the position of the display, the image captured by the camera may need to be corrected to an actual position when viewed in the display of the AR glass. The information on whether the position of the image obtained through at least one camera included in the AR glass is corrected may include information on whether to correct the position of the image when rendering the image captured according to the camera position.

The ICF (Intrinsic parameters Control Flag) field included in a bit 1 of the byte #14 of AR display mode InfoFrame may include information on whether an image displayed through AR glass is an image subjected to camera calibration based on an intrinsic parameter of at least one camera.

The ECF (Extrinsic parameters Control Flag) field included in the bit 2 of the byte #14 of AR display mode InfoFrame may include information on whether an image displayed through AR glass is an image subjected to camera calibration based on an extrinsic parameter of at least one camera.

The Recording video rendering position x offset field included in the byte #15 of the AR display mode InfoFrame and the Recording video rendering position x offset field included in the byte #16 may include information on a change level of a rendering position of a recorded image. If a flag included in the CPCF field indicates 1 or if an ECF field indicates that an image displayed through AR glass is an image subjected to camera calibration based on an extrinsic parameter of at least one camera, a position may be adjusted when an image captured by the camera is rendered. A recoded video rendering position is changeable, and a changed value may be indicated by x-axis and y-axis offsets through the Recording video rendering position x offset field and the Recording video rendering position y offset field. A reference point may be fixed, for example, to a left top point, and a sign bit may be included in the most significant bit. In addition, a z offset value may also be signaled when there is a need to adjust a position in a 3D space.

The Sensor # N transformed capability field included after the byte #17 of the AR display mode InfoFrame may include information on a sensor value of data converted in the media processing device. The information on the sensor value of the data converted in the media processing device may be indicated distinctively as a maximum value/minimum value. If the sensor value converted by the media processing device 900 is expressed as one value, the maximum value/minimum value may be signaled equally.

Next, the AR audio rendering mode field corresponding to the InfoFrame type code 0x0A may be configured as shown in Table 19 below.

TABLE 19

| InfoFrame | InfoFrame Type = 0x0A (AR audio | | | | | | | |
|---|---|---|---|---|---|---|---|---|
| Type Code | rendering mode InfoFrame) | | | | | | | |
| InfoFrame | Version = 0x01 | | | | | | | |
| Version | | | | | | | | |
| Number | | | | | | | | |
| Length of AR | Length of following data bytes | | | | | | | |
| audio rendering | | | | | | | | |
| mode InfoFrame | | | | | | | | |
| Byte # | 7 | 6 | 5 | 4 | 3 | 2 | 1 | 0 |
| Data Byte 1 | R5 | R4 | R3 | R2 | R1 | R0 | MPCF | SPCF |

| | |
|---|---|
| Data Byte 2 | Audio rendering position x offset based |
| | on speaker position |
| Data Byte 3 | Audio rendering position y offset based |
| | on speaker position |
| Data Byte 4 | Audio rendering position z offset based |
| | on speaker position |
| Data Byte 5 | Recording audio rendering position x offset |
| Data Byte 6 | Recording audio rendering position y offset |
| Data Byte 7 | Recording audio rendering position z offset |

The SPCF (Speaker Position Control Flag) field included in the bit 0 of the byte #1 of the AR audio rendering mode InfoFrame may include information on whether an audio signal is controlled based on a position of a speaker included in the AR glass of the media reproducing device 1000. The information on whether the audio signal is controlled based on the position of the speaker included in the AR glass of the media reproducing device 1000 may include a flag, and the flag may indicate 1 if the audio signal is controlled based on the position of the speaker included in the AR glass. In this case, information on a modified position in the audio signal may be transmitted using an offset, and optionally may be indicated by x-, y-, and z-values (or azimuth, elevation, and tilt values) of actual audio instead of the offset. In addition, not only the position of the speaker but also a channel of the speaker can be signaled, and in case of object audio, it may also be extended to control of an audio signal depending on user's object selection.

The MPCF (Mic Position Control Flag) field included in the bit 1 of the byte #1 of the AR audio rendering mode InfoFrame may include information on whether an audio signal recorded by a microphone is controlled based on a position of the microphone included in the AR glass. The information on whether the audio signal recorded by the microphone is controlled based on the position of the microphone included in the AR glass of the media reproducing device 1000 may include a flag, and the flag may indicate 1 if the audio signal recorded by the microphone is controlled based on the position of the microphone included in the AR glass. In this case, information on a modified position in the audio signal may be transmitted using an offset, and optionally may be indicated by x-, y-, and z-values (or azimuth, elevation, and tilt values) of actual audio instead of the offset.

The Audio rendering position x offset based on speaker position field included in the byte #2 of the AR audio rendering mode InfoFrame, the Audio rendering position y offset based on speaker position field included in the byte #3, and the Audio rendering position z offset based on speaker position field included in the byte #4 may include information on a position of a speaker included in the AR glass. More specifically, if the flag included in the SPCF field indicates 1, the media processing device 900 may change an audio signal according to the position of the speaker, and may signal the changed position information.

The Recording audio rendering position x offset field included in the byte #5 of the AR audio rendering mode InfoFrame, the Recording audio rendering position y offset field included in the byte #6, and the Recording audio rendering position z offset field of the byte #7 may include information on the position of the microphone included in the AR glass. More specifically, if the flag included in the MPCG field indicates 1, the media processing device 900 may change a recorded audio signal, and may signal position information on the changed audio signal.

In an embodiment, the Auxiliary Video Information field corresponding to the InfoFrame type code 0x02 may be configured as shown in Table 20 below.

TABLE 20

| InfoFrame Type Code | InfoFrame Type = 0x02 | | | | | | | |
|---|---|---|---|---|---|---|---|---|
| InfoFrame Version Number | Version = 0x04 | | | | | | | |
| Length of AVI InfoFrame | Length of AVI Infoframe (14) | | | | | | | |
| Byte # | 7 | 6 | 5 | 4 | 3 | 2 | 1 | 0 |
| Data Byte 1 | [Y2] | Y1 | Y0 | A0 | B1 | B0 | S1 | S0 |
| Data Byte 2 | C1 | C0 | M1 | M0 | R3 | R2 | R1 | R0 |
| Data Byte 3 | ITC | EC2 | EC1 | EC0 | Q1 | Q0 | SC1 | SC0 |
| Data Byte 4 | [VIC7] | VIC6 | VIC5 | VIC4 | VIC3 | VIC2 | VIC1 | VIC0 |
| Data Byte 5 | YQ1 | YQ0 | CN1 | CN0 | PR3 | PR2 | PR1 | PR0 |
| Data Byte 6 | ETB07-ETB00 (Line Number of End of Top Bar - lower 8 bits) | | | | | | | |
| Data Byte 7 | ETB15-ETB08 (Line Number of End of Top Bar - upper 8 bits) | | | | | | | |
| Data Byte 8 | SBB07-SBB00 (Line Number of Start of Bottom Bar - lower 8 bits) | | | | | | | |
| Data Byte 9 | SBB15-SBB08 (Line Number of Start of Bottom Bar - upper 8 bits) | | | | | | | |
| Data Byte 10 | ELB07-ELB00 (Pixel Number of End of Left Bar - lower 8 bits) | | | | | | | |
| Data Byte 11 | ELB15-ELB08 (Pixel Number of End of Left Bar - upper 8 bits) | | | | | | | |
| Data Byte 12 | SRB07-SRB00 (Pixel Number of Start of Right Bar - lower 8 bits) | | | | | | | |
| Data Byte 13 | SRB15-SRB08 (Pixel Number of Start of Right Bar - upper 8 bits) | | | | | | | |
| Data Byte 14 | ACE3 | ACE2 | ACE1 | ACE0 | F143 = 0 | F142 = 0 | F141 = 0 | F140 = 0 |

| | | | | |
|---|---|---|---|---|
| Data Byte 15 | R0 | LRO | 3DCF | contents type |

| | | | | | | | |
|---|---|---|---|---|---|---|---|
| Data Byte 16 | VT | BLFF | HCF | SCF | BCF | CCF | PCF |

| | | | |
|---|---|---|---|
| Data Byte 17 | Reserved for future use | CBCF | FFCF |

| Data Byte 18 | X offset | | | | |
|---|---|---|---|---|---|
| Data Byte 19 | Y offset | | | | |
| Data Byte 20 | Contrast offset | | | | |
| Data Byte 21 | Brightness offset | | | | |
| Data Byte 22 | Saturation offset | | | | |
| Data Byte 23 | Hue offset | | | | |
| Data Byte 24 | R1 | R0 | Color 2 | Color 1 | Hue offset |

| | |
|---|---|
| Data Byte 25 | Color offset 1 |
| Data Byte 26 | Color offset 2 |
| Data Byte 27 | File format |
| Data Byte 28-31 | Azimuth center |
| Data Byte 32-35 | Elevation center |
| Data Byte 36-39 | Tilt center |

Descriptions on the fields disclosed in Table 20 have been described above with reference to Table 17 to Table 19. When the Auxiliary Video Information field is configured as shown in Table 20, the length of AVI InfoFrame(14) may be changed to the length of AVI InfoFrame (38).

In another embodiment, the Auxiliary Video Information field corresponding to the InfoFrame type code 0x02 may be configured as shown in Table 21 below.

TABLE 21

| InfoFrame Type Code | InfoFrame Type = 0x02 | | | | | | | |
|---|---|---|---|---|---|---|---|---|
| InfoFrame Version Number | Version = 0x04 | | | | | | | |
| Length of AVI InfoFrame | Length of AVI Infoframe (14) | | | | | | | |
| Byte # | 7 | 6 | 5 | 4 | 3 | 2 | 1 | 0 |
| Data Byte 1 | [Y2] | Y1 | Y0 | A0 | B1 | B0 | S1 | S0 |
| Data Byte 2 | C1 | C0 | M1 | M0 | R3 | R2 | R1 | R0 |
| Data Byte 3 | ITC | EC2 | EC1 | EC0 | Q1 | Q0 | SC1 | SC0 |
| Data Byte 4 | [VIC7] | VIC6 | VIC5 | VIC4 | VIC3 | VIC2 | VIC1 | VIC0 |
| Data Byte 5 | YQ1 | YQ0 | CN1 | CN0 | PR3 | PR2 | PR1 | PR0 |
| Data Byte 6 | ETB07-ETB00 (Line Number of End of Top Bar - lower 8 bits) | | | | | | | |
| Data Byte 7 | ETB15-ETB08 (Line Number of End of Top Bar - upper 8 bits) | | | | | | | |
| Data Byte 8 | SBB07-SBB00 (Line Number of Start of Bottom Bar - lower 8 bits) | | | | | | | |
| Data Byte 9 | SBB15-SBB08 (Line Number of Start of Bottom Bar - upper 8 bits) | | | | | | | |
| Data Byte 10 | ELB07-ELB00 (Pixel Number of End of Left Bar - lower 8 bits) | | | | | | | |
| Data Byte 11 | ELB15-ELB08 (Pixel Number of End of Left Bar - upper 8 bits) | | | | | | | |
| Data Byte 12 | SRB07-SRB00 (Pixel Number of Start of Right Bar - lower 8 bits) | | | | | | | |
| Data Byte 13 | SRB15-SRB08 (Pixel Number of Start of Right Bar - upper 8 bits) | | | | | | | |
| Data Byte 14 | ACE3 | ACE2 | ACE1 | ACE0 | F143 = 0 | F142 = 0 | F141 = 0 | F140 = 0 |
| Data Byte 15 | R0 | LRO | | 3DCF | contents type | | | |
| Data Byte 16 | STDF | STCF | BLFF | HCF | SCF | BCF | CCF | PCF |
| Data Byte 17 | Reserved for future use | | | | | CBCF | | FFCF |
| Data Byte 18 | X offset | | | | | | | |
| Data Byte 19 | Y offset | | | | | | | |
| Data Byte 20 | Contrast offset | | | | | | | |
| Data Byte 21 | Brightness offset | | | | | | | |
| Data Byte 22 | Saturation offset | | | | | | | |
| Data Byte 23 | Hue offset | | | | | | | |
| Data Byte 24 | R1 | R0 | Color 2 | | Color 1 | | Hue offset | |
| Data Byte 25 | Color offset 1 | | | | | | | |
| Data Byte 26 | Color offset 2 | | | | | | | |
| Data Byte 27 | File format | | | | | | | |
| Data Byte 28 | R2 | R1 | R0 | MPCF | SPCF | ECF | ICF | CPCF |

| | |
|---|---|
| Data Byte 29 | Recording video rendering position x offset |
| Data Byte 30 | Recording video rendering position y offset |
| Data Byte 31 | Audio rendering position x offset based on speaker position |
| Data Byte 32 | Audio rendering position y offset based on speaker position |
| Data Byte 33 | Audio rendering position z offset based on speaker position |
| Data Byte 34 | Recording audio rendering position x offset |
| Data Byte 35 | Recording audio rendering position y offset |
| Data Byte 36 | Recording audio rendering position z offset |

Descriptions on the fields disclosed in Table 21 have been described above with reference to Table 17 to Table 19. If the Auxiliary Video Information field is configured as shown in Table 21, the length of AVI InfoFrame(14) may be changed to the length of AVI InfoFrame(38). Meanwhile, although video-related fields and audio-related fields are described in Table 21 without distinction, the video-related fields and the audio-related fields may be distinguished in other embodiments according to a version value. In addition, although the InfoFrame of Table 21 is defined by extending the existing AVI InfoFrame version 4, an embodiment is not limited thereto. For example, fields included in Table 21 may be inserted by newly defining the AVI InfoFrame version 5.

Meanwhile, all offset-related fields described above may be configured to include an actual position value instead of an offset value. In addition, although only a changed value (offset) is included in the aforementioned InfoFrames, it may be optionally extended to include signaling on an original value. In addition, all values included in the InfoFrame may be transmitted to the media reproducing device 1000 through a USB or the like.

The media processing device 900 according to an embodiment may transmit a generated media signal and extracted characteristic information to the media reproducing device 1000 (S1330).

According to a method of operating the media processing device 900 described in FIG. 13, a VR or AR media signal may be generated by processing a media bitstream (S1310), based on 3D reproduction environment information of the media reproducing device 1000, received from the media reproducing device 1000 (S1300), more specifically, VR or AR reproduction environment information. The InfoFrame may be generated based on a 3D media signal obtained in a process of processing a media bitstream, more specifically, a VR or AR media signal (S1320). The generated VR or AR media signal and the generated InfoFrame may be transmitted to the media reproducing device 1000 (S1330). That is, according to the method of operating the media processing device 900, while transmitting/receiving 3D media data of the media reproducing device 1000, more specifically, VR or AR media data, the media reproducing device 1000 may generate a VR or AR media signal to more smoothly reproduce VR or AR media content.

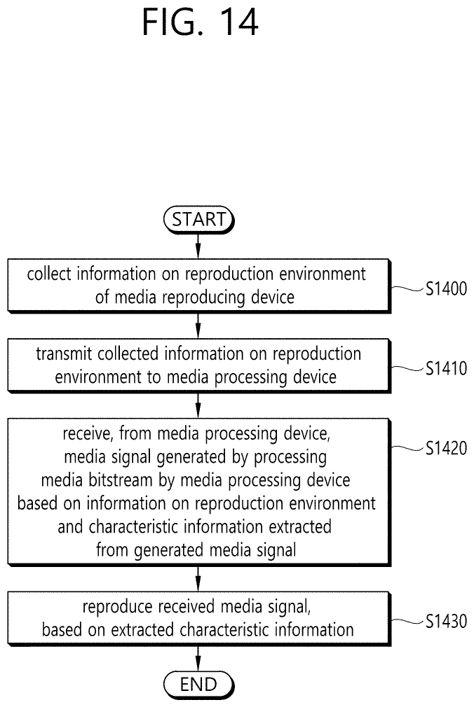

FIG. 14 is a flowchart illustrating a process in which a media reproducing device reproduces media data according to an embodiment.

Each step disclosed in FIG. 14 may be performed by the media reproducing device 1000 of FIG. 10. Specifically, for example, S1400 of FIG. 14 may be performed by the metadata processor 1010 of the media reproducing device 1000, S1410 may be performed by the transmitter 1020 of the media reproducing device 1000, S1420 may be performed by the receiver 1030 of the media reproducing device 1000, and S1430 may be performed by the reproducer 1040 of the media reproducing device 1000. Therefore, in the description of each step of FIG. 14, redundant details described above with reference to FIG. 10 will be omitted or simply described.

In addition, since media data transmitted/received between the media processing device 900 and the media reproducing device 100, for example, the information on reproduction environment of the media reproducing device 1000 and the characteristic information of the media signal extracted from the media processing device 900 have been described above in detail in FIG. 13, detailed description on the media data transmitted/received between the media processing device 900 and the media reproducing device 1000 will be omitted or simply described in FIG. 14.

The media reproducing device 1000 according to an embodiment may collect the information on reproduction environment of the media reproducing device 1000 (S1400). More specifically, the metadata processor 1010 of the media reproducing device 1000 may collect the information on reproduction environment of the media reproducing device 1000, included in a memory (not shown in the figure) of the media reproducing device 1000.

The media reproducing device 1000 according to an embodiment may transmit the collected information on reproduction environment to the media processing device (S1410). More specifically, the transmitter 1020 of the media reproducing device 1000 may receive the information on reproduction environment, transferred from the metadata processor 1010, and thereafter transmit the information on reproduction environment to the media processing device 900.

The media reproducing device 1000 may receive from the media processing device 900 the media signal generated by the media processing device 900 by processing a media bitstream on the basis of the information on reproduction environment and characteristic information extracted from the generated media signal (S1420). More specifically, the receiver 1030 of the media reproducing device 1000 may receive from the transmitter 940 of the media processing device 900 the media signal generated from the media processing device 900 and the characteristic information extracted from the generated media signal.

The media reproducing device 1000 according to an embodiment may reproduce the received media signal, based on the extracted characteristic information (S1430). More specifically, the media signal and the characteristic information extracted from the media signal may be transmitted to the metadata processor 1010, at least one of the media signal and the characteristic information extracted from the media signal may be read from the metadata processor 1010, and the information read in the metadata processor 1010 may be transmitted to the reproducer 1040. The reproducer 1040 may reproduce the received media signal, based on the extracted characteristic information.

However, a method in which the reproducer 1040 reproduces a media signal is not limited thereto. For example, the media signal may be directly transferred from the receiver 1010 to the reproducer 1040, characteristic information extracted from the media signal may be read in the metadata processor 1010 and thereafter transferred to the reproducer 1040, and the reproducer 1040 may reproduce the media signal transferred from the receiver 1010, based on the characteristic information read in the metadata processor 1010.

According to a method of operating the media reproducing device 1000 described in FIG. 14, information on reproduction environment including information on 3D media reproduction of the media reproducing device 1000, more specifically, VR or AR media reproduction, may be collected (S1400), and may be transmitted to the media processing device 900 (S1410). A VR or AR media signal generated by the media processing device 900 on the basis of the information on reproduction environment and characteristic information extracted from the media signal may be received from the media processing device 900 (S1420). That is, while transmitting/receiving VR or AR media data with respect to the media processing device 900, the media reproducing device 1000 may smoothly reproduce VR or AR media content according to a 3D media reproduction environment of the media reproducing device 1000 (S1430).

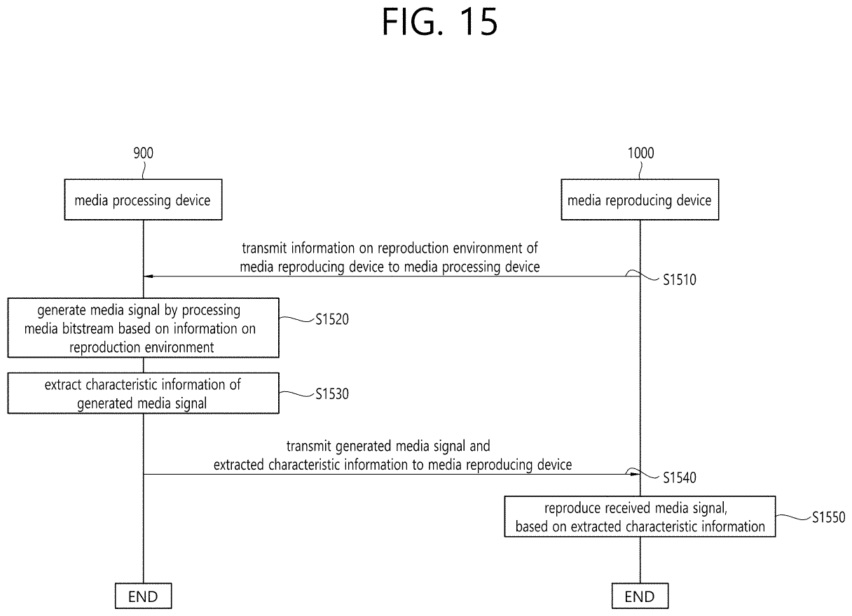

FIG. 15 is a flowchart illustrating a process in which a media processing device and a media reproducing device transmit/receive media data according to an embodiment.

Redundant details described with reference to FIG. 13 and FIG. 14 will be omitted or simply described in with reference to FIG. 15. More specifically, for example, an operation of the media reproducing device 1000 based on S1500 corresponds to an operation of the media reproducing device 1000 based on S1400 of FIG. 14, an operation of the media processing device 900 and media reproducing device 1000 based on S1510 corresponds to an operation of the media processing device 900 based on S1300 of FIG. 13 and an operation of the media reproducing device 1000 based on S1410 of FIG. 14, an operation of the media processing device 900 based on S1520 to s1540 corresponds to an operation of the media processing device 900 based on S1310 to S1330 of FIG. 13, and an operation of the media reproducing device 1000 based on S1540 and S1550 corresponds to an operation of the media reproducing device 1000 based on S1420 and S1430 of FIG. 14. Therefore, redundant detailed descriptions thereof will be omitted.

The media reproducing device 1000 according to an embodiment may collect information on reproduction environment of the media reproducing device 1000 (S1500).

The media reproducing device 1000 according to an embodiment may transmit the information on reproduction environment of the media reproducing device 1000 to the media processing device 900 (S1510). For example, the media reproducing device 1000 may transmit EDID to the media processing device 900 through DDC.

The media processing device 900 according to an embodiment may generate a media signal by processing a media bitstream based on the information on reproduction environment of the media reproducing device 1000 (S1520).

The media processing device 900 according to an embodiment may extract characteristic information of the generated media signal (S1530).

The media processing device 900 according to an embodiment may transmit the generated media signal and the extracted characteristic information to the media reproducing device 100 (S1540).

The media reproducing device 1000 according to an embodiment may reproduce the received media signal, based on the extracted characteristic information (S1550).

Internal components of the aforementioned apparatus may be processors for performing consecutive execution processes stored in a memory, or may be hardware components consisting of other hardware parts. These elements may be disposed to the apparatus internally/externally.

The aforementioned modules may be omitted according to an embodiment, or may be replaced by other modules for performing similar/identical operations.

Each of the aforementioned parts, modules, or units may be a processor or hardware part for performing consecutive execution processes stored in the memory (or storage unit). Each of the steps described in the aforementioned embodiment may be performed by the processor or hardware parts. Each of the modules/blocks/units described in the aforementioned embodiment may operate as a hardware/processor. In addition, methods proposed in the present disclosure may be executed by using code. This code may be written in a storage medium that can be read by the processor, and thus may be read by the processor provided by the apparatus.

Although the aforementioned exemplary system has been described on the basis of a flowchart in which steps or blocks are listed in sequence, the steps of the present disclosure are not limited to a certain order. Therefore, a certain step may be performed in a different step or in a different order or concurrently with respect to that described above. For example, the operation based on step 1320 of FIG. 13 may be performed after the operation based on step 1310 is performed. Optionally, however, the operation based on step 1310 and the operation based on step 1320 may be performed simultaneously by the media processing device 900. Further, it will be understood by those ordinary skilled in the art that the steps of the flowcharts are not exclusive. Rather, another step may be included therein or one or more steps may be deleted within the scope of the present disclosure.

When the embodiments are implemented in software in the present disclosure, the aforementioned method may be implemented using a module (procedure, function, etc.) which performs the aforementioned function. The module may be stored in the memory and executed by the processor. The memory may be disposed to the processor internally or externally and connected to the processor using a variety of well-known means. The processor may include Application-specific Integrated Circuits (ASICs), other chipsets, logic circuits, and/or data processors. The memory may include Read-Only Memory (ROM), Random Access Memory (RAM), flash memory, memory cards, storage media and/or other storage devices.

Internal components of the aforementioned apparatus may be processors for performing consecutive execution processes stored in a memory, or may be hardware components consisting of other hardware parts. These elements may be disposed to the apparatus internally/externally.

The aforementioned modules may be omitted according to an embodiment, or may be replaced by other modules for performing similar/identical operations.

Each of the aforementioned parts, modules, or units may be a processor or hardware part for performing consecutive execution processes stored in the memory (or storage unit). Each of the steps described in the aforementioned embodiment may be performed by the processor or hardware parts. Each of the modules/blocks/units described in the aforementioned embodiment may operate as a hardware/processor. In addition, methods proposed in the present disclosure may be executed by using code. This code may be written in a storage medium that can be read by the processor, and thus may be read by the processor provided by the apparatus.

Although the aforementioned exemplary system has been described on the basis of a flowchart in which steps or blocks are listed in sequence, the steps of the present disclosure are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present disclosure.

When the embodiments are implemented in software in the present disclosure, the aforementioned method may be implemented using a module (procedure, function, etc.) which performs the aforementioned function. The module may be stored in the memory and executed by the processor. The memory may be disposed to the processor internally or externally and connected to the processor using a variety of well-known means. The processor may include Application-specific Integrated Circuits (ASICs), other chipsets, logic circuits, and/or data processors. The memory may include Read-Only Memory (ROM), Random Access Memory (RAM), flash memory, memory cards, storage media and/or other storage devices.

What is claimed is:

1. A media data processing method performed by a media processing apparatus, the media data processing method including:
receiving information on reproduction environment of a media reproducing apparatus from the media reproducing apparatus;
generating media signal by processing a media bitstream based on the information on reproduction environment;
extracting characteristic information of the generated media signal; and
transmitting the generated media signal and the extracted characteristic information to the media reproducing apparatus,
wherein the information on reproduction environment includes at least one of VR (Virtual Reality) reproduction environment information and AR (Augmented Reality) reproduction environment information.

2. The media processing method of claim 1, wherein the information on reproduction environment includes at least one of EDID (Extended Display Identification Data Standard) and DisplayID.

3. The media processing method of claim 2,
wherein the information on reproduction environment includes the EDID, and
wherein the EDID includes at least one CTA data block, and the at least one CTA data block includes a CTA data block including at least one of extended tags.

4. The media processing method of claim 3,
wherein the at least one of extended tags included in the information on reproduction environment includes the VR reproduction environment information, and
wherein the VR reproduction environment information includes at least one of reproducing device-specific VR media data and user-specific VR media data.

5. The media data processing method of claim 4, wherein the reproducing device-specific VR media data includes at least one of information on a type of the media reproducing device, information on the number of displays of the media reproducing device, information on whether the media reproducing device can provide gaze tracking, information on a dimension supported by the media reproducing device, information on an identification of the media reproducing device, information on a minimum luminance value that can be provided by the media reproducing device, information on a maximum luminance value that can be provided by the media reproducing device, information on a file format that can be supported by the media reproducing device, information on a 3D file format that can be supported by the media reproducing device, and information on computing power of the media reproducing device.

6. The media data processing method of claim 4, wherein the user-specific VR media data includes at least one of age information of a user, information on a dominant eye of the user, color blindness information, information on an eyesight of the user, preference information of the user, information on whether the user requests for conversion with a preferred frame rate, information on whether to consider a viewport of the user, information on a display mode preferred by the user, information on a color temperature preferred by the user, information on whether to adjust a position at which the VR media is displayed, and information on adjustment of a range of the VR media.

7. The media data processing method of claim 3,
wherein the at least one extended tag included in the information on reproduction environment includes the AR reproduction environment information, and
wherein the AR reproduction environment information includes at least one of reproducing device-specific AR media data and user-specific AR media data.

8. The media data processing method of claim 7, wherein the reproducing device-specific AR media data includes at least one of information on a see-through of AR glass of the media reproducing device, information on color of a display of the AR glass, information on a horizontal or vertical direction size of an actual display, information on a horizontal or vertical directional size of a virtual display according to a projected distance, information on a sensor included in the AR glass, information on the number of at least one camera included in the AR glass, information on an identification (ID) of at least one camera included in the AR glass, information on a position of the at least one camera included in the AR glass, and information on each of parameters of the at least one camera.

9. The media data processing method of claim 7, wherein the user-specific AR media data includes at least one of age information of a user, information on a dominant eye of the user, color blindness information, information on an eyesight of the user, preference information on the user, information on whether the user requests for conversion with a preferred frame rate, information on a display mode preferred by the user, information on a color temperature preferred by the user, information on whether to adjust a position at which the VR media is displayed, and information on adjustment of a range of the VR media.

10. The media data processing method of claim 3,
wherein the at least one extended tag included in the information on reproduction environment includes the AR reproduction environment information, and
wherein the AR reproduction environment information includes reproducing device-specific AR audio data.

11. The media data processing method of claim 10, wherein the reproducing device-specific AR audio data includes at least one of information on whether at least one speaker is included in AR glass, information on the number of one or more speakers included in the AR glass, information on each position of at least one speaker included in the AR glass, information on whether at least one microphone (MIC) is included in the AR glass, and information on a position of at least one microphone included in the AR glass.

12. The media data processing method of claim 3,
wherein the at least one extended tag included in the information on reproduction environment includes at least one of the VR reproduction environment information and the AR reproduction environment information, and
wherein at least one of the VR reproduction environment information and the AR reproduction environment information includes at least one of VR/AR display metadata information, VR/AR device metadata information, VR/AR audio metadata information, VR specific metadata, and AR specific metadata.

13. The media data processing method of claim 2,
wherein the information on reproduction environment includes DisplayID,
wherein the DisplayID includes at least one of the VR reproduction environment information and the AR reproduction environment information, and
wherein at least one of the VR reproduction environment information and the AR reproduction environment information includes at least one of information on post processing control, reproducing device-specific VR media data, user-specific VR media data, reproducing device-specific AR media data, user-specific AR media data, and reproducing device-specific AR audio data.

14. The media data processing method of claim 13, wherein the information on the post processing control includes at least one of information on whether to activate VR processing in the media processing device on the basis of the reproducing device-specific VR media data, information on whether to activate VR processing in the media processing device on the basis of the user-specific VR media data, information on whether to activate AR processing in the media processing device on the basis of the reproducing device-specific AR media data, information on whether to activate AR processing in the media processing device on the basis of the user-specific AR media data, and information on whether to activate AR processing in the media processing device on the basis of the reproducing device-specific AR audio data.

15. The media data processing method of claim 1,
wherein the extracted characteristic information includes Infoframe, and
wherein the Infoframe includes at least one of VR display mode information, AR display mode information, and AR audio rendering mode information.

16. The media data processing method of claim 15,
wherein the Infoframe includes the VR display mode information, and
wherein the VR display mode information includes at least one of information on the media data type, information on whether the media are displayed as a 3D image, information on whether an image included in the media is displayed in left-right order, information on a dominant eye, information on whether color contrast is changed, information on a level by which the color contrast is changed, information on whether color brightness is changed, information on a level by which the color brightness is changed, information on whether color saturation is changed, information on a level by which the color saturation is changed, information on whether color hue is changed, information on a level by which the color hue is changed, information on whether it is changed to color temperature preferred by a user, information on whether a viewport of the user is considered, information on whether the media field format is changed, information on the changed file format of the media, information on whether media color is changed based on whether the user is color blind, information on a level by which the color of the media is changed based on whether the user is color blind, information on a level by which a position of an image included in the media is changed based on information on the user's dominant eye, and information on a position of the viewport.

17. The media data processing method of claim 15,
wherein the Infoframe includes the AR display mode information, and
wherein the AR display mode information includes at least one of information on whether an image of the media is changed according to a see-through of AR glass of the media reproducing device, information on whether an image of the media is changed according to color of a display of the AR glass, information on whether a position of an image obtained through at least one camera included in the AR glass is corrected, information on whether an image displayed through the AR glass is an image subjected to camera calibration based on an intrinsic parameter of the at least one camera, information on whether an image displayed through the AR glass is an image subjected to camera calibration based on an extrinsic parameter of the at least one camera, information on a change level of a rendering position of a recorded image, and information on a sensor value of data converted in the media processing device.

18. The media data processing method of claim 15,
wherein the Infoframe includes the AR audio rendering mode information, and
wherein the AR audio rendering mode information includes at least one of information on whether an audio signal is controlled based on a position of a speaker included in AR glass of the media reproducing device, information on a position of the speaker, information on whether an audio signal recorded by a microphone is controlled based on a position of the microphone included in the AR glass, and information on a position of the microphone.

19. A media data reproducing method performed by a media reproducing apparatus, the media data reproducing method comprising:
collecting information on reproduction environment of the media reproducing apparatus;
transmitting the collected information on reproduction environment to a media processing apparatus;
receiving from the media processing apparatus a media signal generated by processing a media bitstream in the media processing apparatus on the basis of the information on reproduction environment and characteristic information extracted from the generated media signal; and
reproducing the received media signal, based on the extracted characteristic information,
wherein the information on reproduction environment includes at least one of Virtual Reality (VR) reproduction environment information and Augmented Reality (AR) reproduction environment information.

20. A media data processing apparatus for processing media data, the media data processing apparatus comprising:
a receiver for receiving information on reproduction environment of a media reproducing apparatus from the media reproducing apparatus;
a media signal processor for generating a media signal by processing a media bitstream based on the information on reproduction environment;
a metadata processor for extracting characteristic information of the generated media signal; and
a transmitter for transmitting the generated media signal and the extracted characteristic information to the media reproducing apparatus,
wherein the information on reproduction environment includes at least one of VR reproduction environment information and AR reproduction environment information.
